(19) United States
(12) Patent Application Publication
(10) Pub. No.: US 2016/0104229 A1
(43) Pub. Date: Apr. 14, 2016

(54) UNIVERSAL MARKETING SYSTEM AND METHOD FOR FAMILIES OF PRODUCTS FROM MULTIPLE VENDORS AND SOURCES

(71) Applicant: Mack Craft, St. Augustine, FL (US)

(72) Inventor: Mack Craft, St. Augustine, FL (US)

(21) Appl. No.: 14/973,702

(22) Filed: Dec. 17, 2015

Related U.S. Application Data
(63) Continuation-in-part of application No. 14/334,592, filed on Jul. 17, 2014.

(51) Int. Cl. G06Q 30/06

(52) U.S. Cl. CPC G06Q 30/0631; G06Q 30/0641

(57) ABSTRACT

A “slide-by” display on a computing device includes several sliding, movable, editable display strips of products that slide by swiping gesture. The display may be shared with another user for display on that user's computer. A user-selectable binary locking indicator is associated with each product. Strips without locked products are repopulated, upon user instruction, with products that are relevant to the locked products and meet user-specified constraints. Correlated style codes or category and subcategory information determine relevance. A shopping cart enables purchase from various merchants, with each merchant processing payment. User's may request and receive notifications relating to products.

### RELATED APPLICATIONS

This application is a continuation-in-part and claims the benefit of priority of pending U.S. Nonprovisional application Ser. No. 14/334,592 filed 17 Jul. 2014, which is a continuation-in-part and claims the benefit of priority of pending U.S. Nonprovisional application Ser. No. 14/058,119 filed 18 Oct. 2013, which is a Nonprovisional of and claims the benefit of priority of U.S. Provisional Application No. 61/795,497 filed on 18 Oct. 2012, the entire contents of which are incorporated herein by this reference and made a part hereof.

### FIELD OF THE INVENTION

This invention relates generally to marketing, and, more particularly, to a networked system that displays families of products to users based upon user preferences.

### BACKGROUND

A problem with marketing, whether it involves a conventional advertisement, a coupon, a discount code, or some other form of marketing, is that it often reaches individuals and businesses who are not interested in the promoted business, product or service, and may fail to reach those who are truly interested. Thus, a business pays for broad distribution of an advertisement through print or electronic sources to many consumers, including many who may not be receptive to the advertisement. By way of example a business may publish coupons in a newspaper or other printed publication. Many of those coupons will not reach interested consumers. Many of those coupons will reach consumers lacking interest in the subject matter. While online coupon delivery systems have been devised, such systems are relegated to coupon delivery and still require a consumer to request specific coupons.

Online advertising uses the Internet to deliver promotional marketing messages to consumers. It includes email marketing, search engine marketing, social media marketing, many types of display advertising (including web banner advertising). Like other advertising media, online advertising frequently reaches consumers who are not interested in the content and fails to reach those who may be truly interested.

Online advertisers (typically through their ad servers) often use cookies, which are unique identifiers of specific computers, to decide which ads to serve to a particular consumer. Cookies can track whether a user left a page without buying anything, so the advertiser can later retarget the user with ads from the site the user visited. As advertisers collect data across multiple external websites about a user's online activity, they can create a detailed picture of the user's interests to deliver even more targeted advertising. Often the picture is inaccurate. This aggregation of data is called behavioral targeting. Online advertisers can also target their audience by using contextual and semantic advertising to deliver display ads related to the content of the web page where the ads appear. Re-targeting, behavioral targeting, and contextual advertising all are designed to increase an advertiser's return on investment, or ROI, over untargeted ads.

A problem with such online advertising is that it assumes, often erroneously, that a consumer's web search or a visit to a site or clicking of a hyperlink means that the consumer is interested in the subject matter. This is not always the case. Often, individuals visit online sites and select links inadvertently, mistakenly or indiscriminately, without an interest in the underlying subject matter. Occasionally, a consumer's interest may be transient. By way of example, after a consumer completes the purchase of a new home, that consumer may no longer be interested in home inspection services, notwithstanding prior web searches and online visits to websites promoting such services. In such a case, advertising dollars are squandered and the consumer is alienated if targeted banner ads continue to promote home inspection services to the consumer.

A related problem is unsolicited commercial email, often referred to as SPAM. Such email is often sent indiscriminately to all users on a list, regardless of their interests. Not only does such email consume storage and bandwidth, but it infuriates many consumers. Concomitantly, many email applications do a good job at identifying such email as SPAM and move them to a junk folder or delete them upon receipt. Thus, a consumer may never even see such email.

Other problems are an inability of conventional online marketing to efficiently display a family of products (e.g., an outfit) on a small display to a prospective consumer, and an inability to share an efficiently displayed family of products in real time with friends, and a further inability to display related goods for each item in the family of products.

The invention is directed to overcoming one or more of the problems and solving one or more of the needs as set forth above.

### SUMMARY OF THE INVENTION

To solve one or more of the problems set forth above, in an exemplary implementation of the invention, a consumer-driven centralized marketing system includes a centralized processing engine, a directive repository and a marketing object repository. Participating users may submit directives to the processing engine. Each directive comprises an authoritative instruction pertaining to delivery of electronically deliverable marketing object. A directive may be a consumer directive or a marketing directive. A consumer directive may be one of many different types including, a location directive, a personal information directive, a general directive and a specific directive. A personal information directive may provide a user's gender, race, age, income level, profession, and personal interests to facilitate delivery of marketing objects pertaining thereto. A general directive remains active until canceled. A specific directive and marketing directive instructs the system to which consumers the system should send a particular marketing object. The centralized processing engine saves each received directive as a record in a database referred to as a directive repository. A marketing object may be provided by the user or a third party. A marketing object may comprise any of a wide variety of marketing items, such as coupons, announcements, advertisements, promotional codes, job postings, resumes, personal profiles, etc. . . . . The centralized processing engine may save each received marketing object as a record in a database. In the case of a marketing object provided by a user, a marketing directive provided by that user for the marketing object may specify to whom and when the marketing object may be distributed via the system. A consumer directive instructs the system to deliver certain types of marketing objects to the user via the system.

In one implementation, a “slide-by” display on a computing device includes several separate display sections, each resembling a strip or reel. Each display section, referred to herein as a “strip” visually displays images of a plurality of products, in series, one next to another. The strips are adjacent or abutting one another. Each strip displays images of products that are related to the images of products displayed in each other strip of the display. Each strip may be populated with a plurality of images, videos, pictograms, graphics, text or other displayable indicia, each an object image. The object images of a strip may be arranged in an order. Each strip may slide in one dimension. A user may slide a strip in one direction (e.g., right or up) or the opposite direction (e.g., left or down). As a strip slides, the object image that is displayed progresses (i.e., transitions) to the next or previous product image, in succession, in the strip, according to the order. Each strip may slide independent of each other strip.

Products displayed in a strip have similar characteristics, as determined by descriptive information for each product, as stored in a database or other data source. The descriptive information may comprise categories and subcategories. Categories, subcategories and relationships among categories and subcategories may be stored in one or more tables, databases or other data sources. Category and subcategory information for a product may be supplied manually, from a database, or from an SKU style code (aka style number).

Strips may be arranged in various orders and manners. Strips may be movable. The strips may be dragged by a user or moved by a user using up/down arrow button(s) to a desired relative location. Thus, the strips may be arranged and rearranged according to a user's preferences. A user may remove and add strips. A display may show 1, 2, 3 or more strips. If a screen can display fewer than the total number of strips in an intelligible manner, the user may slide strips downwardly and upwardly to hide and reveal certain strips. A user may select a product to be displayed in a strip. A product is displayed in a strip when an object (e.g., image, pictogram, graphic or text) for the product is displayed in the strip. User selection of a product to be displayed in a strip may be made using any of various input mechanisms, including a keyboard, pointer, touch screen, microphone or camera.

Data for one or more strips and one or more products may be shared with another user. Sharing communicates data for the strips and/or products to the other user on a compatibly equipped computing device.

A product may be locked. Locking is a form of user selection. A binary locking indicator is associated with each product in each strip. When a product is locked, it will remain in the strip. The system will not remove a locked product from a strip, without user instruction to do so

Strips devoid of a locked product may be repopulated upon a matching instruction. Matching repopulates each strip that does not contain a locked product with products that are particularly relevant to the locked products. Matching may be subjected to constraints, such as filters and limits.

In one exemplary implementation, a method of displaying information for a plurality of products, including alternative products and related products, entails receiving data corresponding to an anchor product and obtaining from a database, information regarding the anchor product, the information including an anchor product pictogram, a category association, and at least one subcategory association. Information regarding a first plurality of products is obtained from the database. Each product of the first plurality of products is an alternative to the anchor product and has a category association and a subcategory association that are the same as the category association and subcategory association for the anchor product. The information regarding the first plurality of products includes, for each product of the first plurality of products, a product pictogram and comprises a first strip.

Information regarding a second plurality of products is also obtained from the database. Each product of the second plurality of products is related to the anchor product and has a category association that is the same as the category association for the anchor product, and has a subcategory association that is different from the subcategory association for the anchor product. The information regarding the second plurality of products includes, for each product of the second plurality of products, a product pictogram and comprises a second strip.

A first displayable portion of the first strip and a second displayable portion of the second strip are simultaneously displayed on a display screen of a computing device. The first strip includes a first series of product pictograms, including the anchor product pictogram and each pictogram for each product of the first plurality of products. The first displayable portion includes fewer than all of the pictograms in the first series of product pictograms. The second strip includes a second series of product pictograms, including each pictogram for each product of the second plurality of products. The second displayable portion includes fewer than all of the pictograms in the second series of product pictograms.

A first user command to change the pictograms of the first series of product pictograms that are contained in the first displayable portion is received. In response to the received first user command, the pictograms of the first series of product pictograms that are contained in the first displayable portion are changed. A second user command to change the pictograms of the second series of product pictograms that are contained in the second displayable portion is received. In response to the received second user command, the pictograms of the second series of product pictograms that are contained in the second displayable portion are changed. Each of these user commands may be a swiping gesture, with the change taking place as a sideways scrolling of the displayed pictograms in response to the swiping gesture.

Information regarding a third plurality of products may be obtained from the database. Each product of the third plurality of products is related to the anchor product and has a category association that is the same as the category association for the anchor product, and has a subcategory association that is different from the subcategory association for the anchor product and different from the subcategory association for the second plurality of products. The information regarding the third plurality of products includes, for each product of the third plurality of products, a product pictogram. The information regarding the third plurality of products comprises a third strip.

A third displayable portion of the third strip is simultaneously displayed with the first displayable portion of the first strip and the second displayable portion of a second strip on the display screen of the computing device. The third strip includes a third series of product pictograms, including each pictogram for each product of the third plurality of products. The third displayable portion includes fewer than all of the pictograms in the third series of product pictograms.

A third user command to change the pictograms of the third series of product pictograms that are contained in the third displayable portion is received. In response to the received third user command, the pictograms of the third series of product pictograms that are contained in the third displayable portion are changed. Each of these user commands may be a swiping gesture, with the change taking place as a sideways scrolling of the displayed pictograms in response to the swiping gesture.

Information regarding a fourth plurality of products may also be obtained from the database. Each product of the fourth plurality of products is related to the anchor product and has a category association that is the same as the category association for the anchor product, and has a subcategory association that is different from the subcategory association for the anchor product and different from the subcategory association for the second plurality of products and different from the subcategory association for the third plurality of products. The information regarding the fourth plurality of products includes, for each product of the fourth plurality of products, a product pictogram, and comprises a fourth strip.

A fourth displayable portion of a fourth strip is determined. The fourth strip includes a fourth series of product pictograms, including each pictogram for each product of the fourth plurality of products. The fourth displayable portion has fewer than all of the pictograms in the fourth series of product pictograms. In response to a user scroll command (e.g., an upward or downward swiping gesture or upward or downward arrow), three displayable portions of the first displayable portion, second displayable portion, third displayable portion and fourth displayable portion, are simultaneously displayed on the display screen of the computing device, as determined by the user scroll command.

A fourth user command to change the pictograms of the fourth series of product pictograms that are contained in the fourth displayable portion is received. In response to the received fourth user command, the pictograms of the fourth series of product pictograms that are contained in the fourth displayable portion are changed.

The step of receiving data corresponding to an anchor product may include entering into the computing device a universal product code for the anchor product, or determining a universal product code for the anchor product from a photograph of a barcode representation of a universal product code for the anchor product, or receiving data corresponding to an anchor product from a remote computer via a communications network.

The step of receiving a first user command to change the pictograms of the first series of product pictograms that are contained in the first displayable portion may entail swiping a finger across the first displayable portion on a touch sensitive screen and receiving swiping gesture input from a finger swiped across the first displayable portion on a touch sensitive screen.

Style codes may encode category and subcategory information for a product. An anchor product style code for the anchor product may encode the category association for the anchor product and each subcategory association for the anchor product. Style codes, including one style code for each of the first, second, third, fourth, fifth and sixth plurality of products, may encode the category association and each subcategory association for each product.

One or more strips may be repopulated with information, including pictograms for different products, products that match (i.e., are related to) a locked product in another strip. By way of example, a user command to repopulate the second plurality of products and the third plurality of products may be received. In response to the user command to repopulate the second plurality of products and the third plurality of products, information regarding a fifth plurality of products and a sixth plurality of products is obtained from the database. Each product of the fifth and sixth plurality of products is related to the anchor product and has a category association that is the same as the category association for the anchor product, and has a subcategory association that is different from the subcategory association for the anchor product. The information regarding the fifth and sixth plurality of products includes, for each product of the fifth and sixth plurality of products, a product pictogram. The information regarding the fifth and sixth plurality of products comprises a fifth strip replacing the second strip and a sixth strip replacing the third strip, each of which includes product pictograms. The first displayable portion of the first strip, fifth displayable portion of the fifth strip and the sixth displayable portion of a sixth strip are simultaneously displayed on a display screen of a computing device.

A lock status may be associated with each product in each of the strips. The lock status may be locked or unlocked (e.g., 0 or 1). Each strip that dopes not have a locked product may be repopulated as described above, upon user command, while each strip having a locked product is not repopulated.

Repopulation may be subject to constraints, e.g., limits. For example, a price limit may be set. Then, each strip that is repopulated, will be repopulated with products that satisfy the constraint, e.g., have a price that does not exceed the limit.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram illustrating components of an exemplary system according to principles of the invention; and

FIG. 2 is a high level block diagram of components of an exemplary mobile device with a touch sensitive screen for use with an exemplary system according to principles of the invention; and

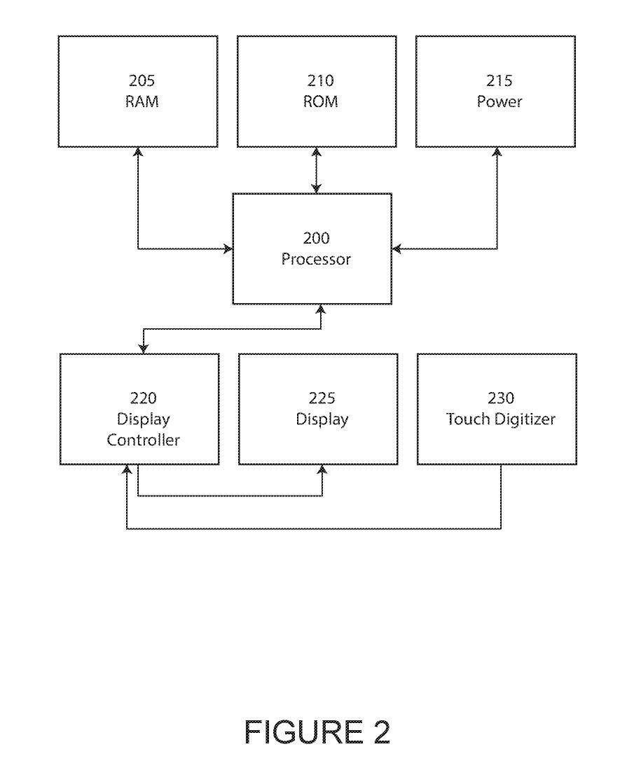

FIG. 3 is a high level block diagram of software modules of an exemplary system according to principles of the invention; and

FIG. 4 is a perspective view of an exemplary mobile device with a touch sensitive screen for use with an exemplary system according to principles of the invention; and

FIG. 5 is a perspective view of an exemplary mobile device with a touch sensitive screen for use with an exemplary system according to principles of the invention; and

FIG. 6 is a high level flowchart of an exemplary method of simultaneously displaying and arranging a plurality of photos or pictograms to facilitate browsing and purchasing decisions using an exemplary system according to principles of the invention; and

FIG. 7 is a high level schematic illustrating data associations for a database for an exemplary system according to principles of the invention; and

FIG. 8 is a schematic of a mobile device simultaneously displaying a plurality of photos or pictograms to facilitate browsing and purchasing decisions using an exemplary system according to principles of the invention; and

FIG. 9 is a schematic of display reels for a mobile device simultaneously displaying a plurality of photos or pictograms to facilitate browsing and purchasing decisions using an exemplary system according to principles of the invention; and

FIG. 10 provides a high level flowchart of steps of an exemplary matching process according to principles of the invention; and

FIG. 11 provides a high level schematic of exemplary data relationships for a database for an exemplary system according to principles of the invention; and

FIG. 12 is a high level flowchart illustrating steps of a method of inputting a product code (e.g., UPC code) from a photographed barcode; and

FIG. 13 is a high level flowchart illustrating steps of a method of purchasing one or more displayed products from one or more vendors according to principles of the invention; and

FIG. 14 is a high level flowchart illustrating steps of requesting and obtaining notifications of the occurrence of one or more specified conditions relating to displayed subject matter according to principles of the invention.

Those skilled in the art will appreciate that the figures are not intended to illustrate every embodiment of the invention. The invention methodology is not limited to the exemplary implementations depicted in the figures or the specific components, configurations, steps, or order of steps as shown in the figures. The text assigned to flowchart steps and block diagram elements are provided for reference purposes and not intended to limit any such element, step or the invention.

### DETAILED DESCRIPTION

In accordance with principles of the invention, a display on a computing device includes several separate display sections, each resembling a strip or reel. Each display section, referred to herein as a “strip” visually displays images of a plurality of products, in series, one next to another. The strips are adjacent or abutting one another. Each strip displays images of products that are related to the images of products displayed in each other strip of the display. Each strip may be populated with a plurality of images, videos, pictograms, graphics, text or other displayable indicia, each an object image. The object images of a strip may be arranged in an order. Each strip may slide in one dimension. A user may slide a strip in one direction (e.g., right or up) or the opposite direction (e.g., left or down). As a strip slides, the object image that is displayed progresses (i.e., transitions) to the next or previous product image, in succession, in the strip, according to the order. Each strip may slide independent of each other strip. Such a display, comprised of a plurality of adjacent or abutting strips, is referred to herein as a “slide-by” display.

The term “product” is not limited to tangible goods. Instead, as used herein, including in the claims, the term “product” encompasses goods, services, and anything else that can be acquired or received by a person.

In a preferred implementation, products displayed in a strip have similar characteristics, as determined by descriptive information for each product, as stored in a database or other data source. The descriptive information may comprise categories and subcategories. Categories are any of several fundamental and distinct classes to which objects belong. A few non-limiting examples of categories are clothing, cookware, and tools. Subcategories are any of several fundamental and distinct subclasses to which objects in a category belong. Illustratively, a few non-limiting examples of subcategories for clothing are gender (e.g., male, female or unisex), brand, style (e.g., athletic, outdoor, work, evening, sleep), occasion (casual, formal), color, size, material, price, sale (e.g., yes/no, discount amount, discount percent), popularity, review rating, etc. . . . . Subcategories may be related and hierarchical. For example, certain subcategories may apply only to certain higher level subcategories. Illustratively, a height subcategory may apply to a boot style subcategory in a category of footwear. Categories, subcategories and relationships among categories and subcategories may be stored in one or more tables, databases or other data sources. Category and subcategory information for a product may be supplied manually, from a database, or from an SKU style code.

Thus, in accordance with principles of the invention, a strip for women's black evening shoes may be populated with pictograms for a plurality of such goods. Another strip for women's knee length skirts may be populated with pictograms for a plurality of such goods. A third strip for women's blouses may be populated with pictograms for a plurality of such goods. The three strips may comprise a slide-by display.

The strips may be arranged in various orders and manners. The three strips may be arranged in a logical order. In the example provided above, a logical order may place the strip for the shoes on bottom, and the strip for the skirts between the strip for the shoes and the strip for the blouses.

To implement a logical ordering, an ordering rank may be associated with one or more subcategories. Ranking indicates the relevance of products displayed in one strip to products displayed in another strip. Illustratively, cross training shoes are more related to gym wear, than they are to formal wear. The ranking for cross training shoes may include an ordered list of subcategories to which the cross training shoes are related, with the strongest relationship first and the weakest relationship last. In this manner, the system may determine a logical arrangement of strips, and a logical selection of products to populate the strips.

The strips may be movable. The strips may be dragged by a user or moved by a user using up/down arrow button(s) to a desired relative location. Thus, the strips may be arranged and rearranged according to a user's preferences.

A user may remove and add strips. A display may show 1, 2, 3 or more strips. If a screen can display fewer than the total number of strips in an intelligible manner, the user may slide strips downwardly and upwardly to hide and reveal certain strips.

A user may select a product to be displayed in a strip. A product is displayed in a strip when an object (e.g., image, pictogram, graphic or text) for the product is displayed in the strip. The object may be a pictogram that is hyperlinked to more detailed information and/or shopping cart functionality for the product.

An anchor product is not displayed alone in a strip. Rather, it is displayed along with alternative products. An alternative product is a product having characteristics that are similar to the characteristics of the anchor product. Such characteristics are determined according to categories and subcategories associated with a product. A user may select alternative products to be displayed in a strip. Additionally, a system according to principles of the invention may populate a strip with alternative products to be displayed. If a limited number of similar products are displayed in a strip, the limited number of products may be determined according to user selection or according to one or more algorithms, including algorithms basing selection on degree of similarity, popularity, ratings, price, or any other criteria that can be determined from the available data.

Data for one or more strips and one or more products may be shared with another user. Sharing communicates data for the strips and/or products to the other user on a compatibly equipped computing device.

User selection of a product to be displayed in a strip may be made using any of various input mechanisms, including a keyboard, pointer, touch screen, microphone or camera. Illustratively, a user may request or accept a notification that provides information about a celebrity's attire at a particular event, or a user may select one or more products while browsing online, or a user may photograph a barcode, or a user may speak each digit of a UPC code into a microphone, or a friend may send product information to a user for use in a slide-by display, or a user may request a product by selecting product characteristics. These are non-limiting examples of processes for selecting a product to be displayed in a strip. Such a selected product may be considered an “anchor product.”

The database may contain information about the attire worn by a celebrity at each appearance or event. Information about a celebrity's attire may be supplied by a user who is a fan of the celebrity, the celebrity, an agent for the celebrity, the designer of one or more garments of the attire, a vendor of the garments of the attire, or another source. A user may search the database 170 for information about the celebrity's attire using the user's portal to the system. A user who has previously expressed interest in a program, event or celebrity may receive notification of the availability of information pertaining to the celebrity's attire. Such information may be pushed to the user's app in response to a prior directive from the user. The attire may be displayed in a slide-by display as discussed below.

A product may be locked. Locking is a form of user selection. A binary locking indicator is associated with each product in each strip. The indicator is set at unlocked as a default. A user may change the locking indicator by selecting a locking icon. Each time the locking icon is selected, the locking indicator changes (e.g., from unlocked to locked, then from locked to unlocked, and so on). When a product is locked, it will remain in the strip. The system will not remove a locked product from a strip, without user instruction to do so.

Strips devoid of a selected product may be repopulated upon user instruction. The instruction is referred to herein as match or matching. Matching repopulates each strip that does not contain a locked product with products that are particularly relevant to the locked products. Repopulation entails populating a strip using data collected for products that are particularly relevant to the locked products of other strips. Relevance may be determined by correlating the subcategories for a locked product with the subcategories of candidates for repopulation, according to matching rules (i.e., rules of matching).

Matching rules may indicate subcategories for a product category that correlate with subcategories of another product category. The rules may organize the matching subcategories in order of matching relevance. Thus, matching data may be associated with each product.

Matching may be subjected to constraints, such as filters and limits. A filter may include or exclude one or more subcategories from the matched data. A limit may exclude data for products that exceed or fall below a user specified limit. By way of example, a budget limit may filter out (i.e., exclude) product data for products that exceed a specified amount.

An implementation of the present invention may be embodied in hardware and/or in software (including firmware, resident software, micro-code, etc.). Furthermore, the present invention may take the form of one or more computer program products on one or more computer-usable or computer-readable storage media having computer-usable or computer-readable program code embodied in the media for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific non-limiting examples (a non-exhaustive list) of a computer-readable medium include random access memory (RAM), a read-only memory (ROM), an erasable programmable read-only memory (EPROM or Flash memory), a hard disk drive, a solid state drive, a portable compact disc read-only memory (CD-ROM), a Blu-ray disc (BD).

Computer program code or “code” for carrying out operations (e.g., steps) according to the present invention may be written in any programming language compatible with the corresponding computing devices and operating systems. Software embodiments of the present invention do not depend on implementation with a particular programming language.

The computer program code may be provided to a processor of a general-purpose computer, special purpose computer, or other programmable computing apparatus (e.g., a phone, personal digital assistant, tablet, laptop, personal computer, or computer server) as instructions to produce a machine, such that the instructions, which execute via the processor of the computer or other programmable data processing apparatus, create means for implementing the functions specified in the illustrations. The computer code may be stored in a computer-readable memory that can direct a computer or other programmable data processing apparatus to function in a particular manner, such that the instructions stored in the computer-readable memory produce an article of manufacture including instruction means which implement the functions and perform the steps specified in the illustrations and described herein.

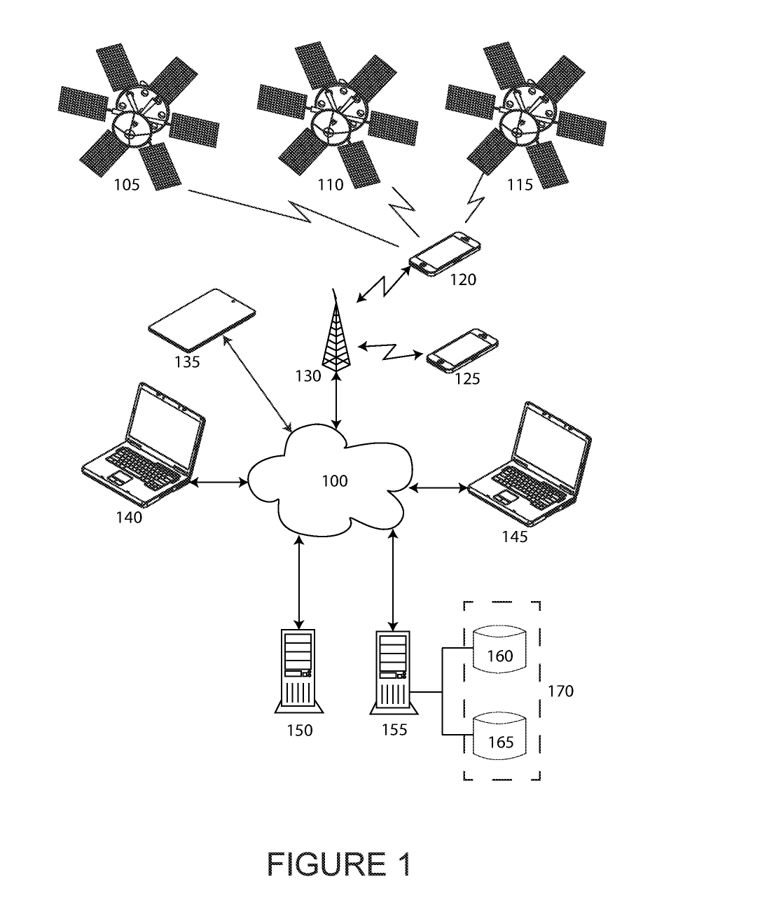

Referring now to FIG. 1, a high level block diagram of hardware components of a system according to principle of the invention is conceptually illustrated. Consistent with the present invention, users of the system use computing devices, such as a cellular phones 120, 125, a tablet 135, a laptop computer 140, 145, or a desktop computer 150, communicating in a wireless or wired mode, with and through one or more web servers 155, via the Internet 100. The computing devices (i.e., clients or client devices) are equipped with software for inputting and displaying information. Such software may comprise a web browser and/or a mobile device app. Some computing devices 120, 125 may be equipped with cellular wireless communication modules providing Internet access via wireless cellular communication infrastructure 130.

In certain embodiments of a system and methodology according to the principles of the invention, a user's location may be specified. Location may be user input or automatically determined using GPS data, IP trace or triangulation information. Some computing devices may be equipped with Global Positioning System (“GPS”) receivers for receiving signals from GPS satellites 105-115 to determine location of the device.

Certain clients 120, 125, 135-150 may not have access to a GPS service (for example, they may lack hardware necessary to support such a service); consequently, such GPS information may not be available for all clients 120, 125, 135-150. Also, it is observed that certain GPS services do not operate or do not operate well in certain locations, such as indoors. Thus, even if a client 120, 125, 135-150 does have the necessary hardware and software to support a GPS service, occasionally GPS information from the GPS service may not be available to a particular client 120, 125, 135-150.

IP trace information may include the public IP address of the client 120, 125, 135-150 and the set of IP addresses that data packets sent from the client 120, 125, 135-150 pass through to reach server 150. The public IP address of the client 120, 125, 135-150 may be determined by gathering the source IP address from the server socket receiving the client 120, 125, 135-150 connection. The list of hops through which the data packets sent from the client 120, 125, 135-150 go through may be determined by sending adaptive TTL (time to live) UDP packets to server 150 from the client 120, 125, 135-150. In order to determine if the client 120, 125, 135-150 is being an IP proxy, server 150 may correlate the list of hops with the public IP address of the client 120, 125, 135-150. In this way, server 150 may effectively discover the real public IP address of the client 120, 125, 135-150. The real public IP address of the client 120, 125, 135-150 is then matched against a database of Internet Service Providers (ISPs) which returns the probable address of the originating client 120, 125, 135-150 message. This probable address of the originating client 120, 125, 135-150 message may then be translated to a set of longitude and latitude coordinates.

Triangulation information for a client 120, 125, 135-150 may include a list of public Wi-Fi access points surrounding the client 120, 125, 135-150 as well as the signal strength of each Wi-Fi access point accessible by the client 120, 125, 135-150. The list of surrounding Wi-Fi access points, and their signal strength, may be formatted and correlated with a database of public Wi-Fi access points by server 150 to determine a probable set of longitude and latitude coordinates for the client 120, 125, 135-150. The database of public Wi-Fi access points employed by server 150 may be updated over time to reflect new information about available Wi-Fi access points.

The invention is not dependent upon location information. Certain implementations of the invention may not take location into consideration. In implementations that take location into consideration, certain types of location data may be more accurate or reliable than others. GPS information is more accurate and indicative of the correct physical location of a client 120, 125, 135-150; however, as explained above, GPS information for a particular client 120, 125, 135-150 may not always be available. Triangulation information, while not as accurate and reliable in identifying the correct physical location of a client 120, 125, 135-150 as GPS information, is more accurate and reliable than IP trace information. However, triangulation information also may not always be available, e.g., the client 120, 125, 135-150 may not be able to detect any nearby recognizable Wi-Fi access points. Additionally, while IP trace information is less accurate than either GPS information or triangulation information in determining the correct location of a client 120, 125, 135-150, it is always obtainable if the client 120, 125, 135-150 can communicate to server 150 over the Internet.

Additionally, a consumer may input location (e.g., an address) for a device, such as a personal computer, laptop 140, 145 or tablet 135, that may not be equipped with a GPS receiver. For a device, such as a desktop computer, at a fixed location, the location of the device may be known and associated with a unique identifier (e.g., MAC address) for the device.

The term “service provider” is used herein to mean any entity that provides a service using a system or methodology according to principles of the invention. The service provider may be, for example, an online service provider with a web-accessible system that receives and processes directives and marketing objects according to principles of the invention. The term “consumer” or “customer” is used herein to mean any individual or entity that requests or seeks marketing objects or goods or services of a business, whether for free or in exchange for compensation. The term “user” or “end user” is used herein to mean any individual or entity that uses the system, whether as a business promoting goods or services or as a consumer interested in procuring goods or services.

Using the computing device 120, 125, 135-150 and client software (“client”) such as a browser or app, a user may create a directive. A directive comprises an authoritative instruction pertaining to delivery of an electronically deliverable marketing object. A directive may be a consumer directive or a marketing directive. A consumer directive may be one of many different types, including, but not limited to, a location directive, a personal information directive, a general directive and a specific directive. The system stores data for each directive as one or more records in a database 170. A user may access, change and delete directives using the system.

Referring still to FIG. 1, one or more computers such as server 155 includes or has access to a database management system for managing product data. One or more database may contain aggregations of data records or files, pertaining to products, users, and directives. A communications network interconnects the server 155, directly or indirectly through one or more additional computers, with the Internet 100. Interconnected computers communicate with each other through mechanisms such as interprocess communication, remote procedure call, distributed object interfaces, and various other program interfaces. The databases may be stored on one or more storage devices 160, 165, collectively the data storage 170. The database may be queried using various database access means such as SQL (Structured Query Language), a standard language for interacting with a database; Open Database Connectivity (ODBC), an open standard API for accessing a database; DCOM (Distributed Component Object Model), a set of Microsoft tools and program interfaces for enabling client program objects to request services from server program objects on another networked computer; Common Object Request Broker Architecture (CORBA), an architecture and specification which allows programs at different locations and developed by different vendors to interact in a network through an interface broker. Illustratively, the clients 120, 125, 135-150 may execute one or more processes that interact server 155 to access data, such as product data, stored on the data storage 170. Each request received by the server 155 may be submitted as a TCP/IP communication packet including an IP address and socket number. In response to valid requests, the server 155 may provide data from the data storage 170, without compromising the integrity of the database.

A location directive identifies the user and provides location information for the user. The location information may comprise an address such as a home, business or temporary address, or another location. A location directive may be time bound, i.e., effective for a user-specified period of time.

A personal information directive may provide some or all of a user's gender, race, age, religion, marital status, income level, education level, profession, and personal interests to facilitate delivery of marketing objects pertaining thereto. Items of data may be optional, to accommodate users with heightened sensitivity to privacy and/or anonymity.

A general directive remains active until canceled. A general directive identifies goods, services, categories of goods and services, brands, or other identifiable classificatory division of subject matter that is of interest or desired by a user. The general directive identifies the user and the subject matter of interest. A graphical user interface may present a user with a form that allows a user to identify a multitude of subject matter of interest. From the form, a general directive may be produced for each subject matter. By way of example and not limitation, one category may be pickup trucks and another category may be Ford F 150 ® pickup trucks.

A specific directive is an immediate request. A specific directive identifies goods, services, categories of goods and services, brands, or other identifiable classificatory division of subject matter that is presently required by a user. The specific directive identifies the user and the subject matter required. A graphical user interface may present a user with a form that allows a user to identify each subject matter required. From the form, a specific directive is produced for each subject matter. Specific directives are processed immediately or as soon as practicable. A specific directive may be time bound, i.e., limited in duration (e.g., for a day, week, month, until an end date, etc. . . . ). By way of example and not limitation, a specific directive may request coupons for a particular business. The specific directive may be limited to a particular day when the coupons are needed. After that day, the coupons will not be provided unless requested again.

The service provider's computing device 155 includes a server (e.g., web server) accessible via a network such as the Internet 100. The server 155 is communicatively coupled to one or more databases 160, 165 and operates a database management system (DBMS) that stores, updates, sorts, queries and analyzes structured data in one or more databases 160, 165, and produces reports and output based on the data. The databases 160, 165 may be resident on or local to the server 155, or remote from the server, hosted by a third party and accessible via a network such as the Internet 100. Collectively, the databases are referred to as a database 170.

A marketing directive instructs the system to which users the system should send a corresponding marketing object. A marketing directive may specify users by subject matter of interest or by personal attribute or by location, as set forth in consumer directives (e.g., location, personal, specific or general directives). A marketing directive is associated with a marketing object. The marketing object is an image, file, stream or data that will be forwarded to each user with a consumer directive that matches a marketing directive. The marketing object may be stored in the database 170.

Time bound provisioning is available. All directives may be time bound. In other words, a directive may be active for a limited period of time, defined in hours, days, weeks, months or years. For example, a general directive may be time bound for a year. The user associated with the general directive may receive a reminder of the time limit prior to the expiration, giving the user a chance to re-provision or remove the time limit. As another example, a merchant user may impose a time limit on a marketing directive for a coupon. The marketing directive may expire on a determined date.

Unit provisioning is also available. For example, a merchant may want to limit a marketing directive to a maximum of 100 or 1000 or 100000 users or transactions. In this case, after the unit limit is reached, the marketing directive expires. The unit limit is reached when the number of copies made available to users equals the unit limit or when the number of transactions using the marketing directive (e.g., using a coupon provided with the marketing directive) exceeds a unit (e.g., transactional) limit. For fairness, in one implementation, the limited number of users may be determined randomly, or using a random selection algorithm, from all users with consumer directives to which the marketing directive is responsive. Alternatively, the limited number of users may be selected based on seniority of their consumer directives—first posted, first served. These and other user selection criteria may be employed if a unit limit must be applied. In the case of a transactional unit limit, the limit may be applied on a first come first served basis.

A database management system executable via the server 155 saves each received directive as a record in a database referred to as a directive repository 160, 165. Directives and marketing objects may be stored in the same or separate databases. Consumer directives and marketing directives may be stored in the same or separate databases. Other data, including user account data and online shopping data may also be stored in repositories 160, 165 or one or more other databases.

The database management system, also referred to as an engine, provides processing, including querying and distribution. Querying entails searching for and retrieving information from the database 170. By way of example, a query may be run for each marketing directive to identify matching consumer directives. Then, each marketing object associated with the marketing directive may be provided to or made accessible to the user associated with each matching consumer directive. If a user has several consumer directives that match a marketing directive, only one copy of the marketing object should be sent or made available. A consumer directive matches a marketing directive when the consumer directive identifies the subject matter of the marketing directive. Marketing objects may be provided to users by sending copies, such as by email or SMS messaging, or by providing a link or other form of notification for the user to access or download the marketing object. In this manner, businesses may push advertisements, information, and coupons to consumers.

A marketing object may be provided by a consumer or a business. A marketing object may comprise any of a wide variety of marketing items, such as coupons, announcements, advertisements, promotional codes, job postings, resumes, personal profiles, etc. . . . . Thus, as one nonlimiting example, a marketing object may comprise a coupon (as broadly defined above) for a restaurant to be sent to all users in a certain location (e.g., northeast Florida) who have entered a directive for restaurants, or restaurants of the particular type, or that particular brand of restaurant. As another nonlimiting example, a marketing object may comprise an individual's resume, to be made available to all business users in a certain location (e.g., southern California) who have posted a consumer directive seeking employees in the field of endeavor specified in the marketing directive associated with the resume. As yet another example, a marketing object may comprise information about a new product or event to be sent to all users who have expressed interest in the product or event, or in products or events of the kind.

The system includes a portal for registered users to access features of the system. The portal may be accessed via a web page and/or an app (i.e., an application executable on a computing device). Through the portal, a user may create a directive and/or provide a marketing object. The portal may provide user-navigable forms to facilitate directive creation and marketing object submission.

Illustratively, a form may include form controls and fields to be manipulated and completed by a user. Such controls and fields may include check buttons, radio buttons, sliders, list boxes, drop-down lists, spinners, combo boxes, text boxes and upload buttons. The form data is associated with the user account. The form data specifies the subject matter of the directive. The form data for a user is stored in one or more databases 160, 165 of the system. The user may retrieve, edit, deactivate and otherwise modify the user's form data using the portal.

The system may receive location information from users in the form of a location directive. Location information may comprise a home address, a business address, one or more other addresses, or a current location of the user as determined from location data such as GPS data from a user's smart-phone or other electronic device. The system may utilize a location directive to provide, to a consumer-user, local marketing objects responsive to a directive.

Businesses may create, modify, activate and deactivate advertisements and coupons using the portal. The portal allows businesses to manage marketing directives. Business users may track all of their marketing directives and associated advertisements, coupons and other marketing objects using the portal. An existing marketing directive may be modified, activated, deactivated, renewed and reactivated. New marketing directives may be created. The value of a coupon may be changed by a business. A business may temporarily limit a coupon to a day, days, weeks, months or any combination of dates. Usage data for a marketing directive may be monitored. Reports may be produced to summarize marketing directives and associated data. Additionally, using the portal, a business may create a web page, which may include a description of the business, its products, key personnel and contact information.

A specific directive may include current location information for a user. Thus a user may request a location-specific marketing object. Location information may be specified by a user in a directive (e.g., via entering an address, zip code, city or some other geographical identifier), or by selecting a capture location button, or automatically using a GPS receiver (or other means) of the computing device. In the latter case, upon installation of an app or upon first use, a user may authorize automatic location determination from a device's available GPS receiver or by other means (as discussed above).

Where location specific directives are processed, the service provider system 155 may respond with marketing objects for the particular location or in the vicinity. The vicinity may be defined by one or more zip codes, a geographical area defined by a radius, or some other means for determining nearby merchants. The vicinity may be limited by a mode of travel, as inputted by a consumer. By way of example, the vicinity, for walking, may comprise a more limited area than the vicinity for driving. In one preferred embodiment, the service provider system 155 responds with a number of marketing objects for the closest merchants of the type requested. For example, the service provider system 155 may respond with five, seven, ten or some other number of coupons for the closest restaurants of the type requested in a consumer directive.

By setting a vicinity as described above, the distance a user may travel to take advantage of an offer may be set by the user, so that offers too far away will be filtered. Conversely, businesses may want to target local consumers, limiting their marketing directives to users within specified geographic areas. Again, this may be accomplished by setting a vicinity for a marketing directive.

The service provider system 155 archives directives, including the date and time of the directive, a geographic identifier (e.g., zip code) for the directive, and the subject matter requested. Each directive is associated with a user's account. The archived information is useful. Knowing how many requests for a particular type of merchant in a particular geographic area and on what days and at what times, is useful for determining whether and how a local merchant may benefit from participating in a system according to principles of the invention. Such information is also useful to existing and prospective participating merchants and advertisers. Concomitantly, savings realized by consumer-users and other successes may be determined from the archived data.

Marketing objects provided with the system may include a unique code for each copy provided to each user. For example, the code may be a field (e.g., function) that is based upon the user's unique identification. In this manner, it is possible to determine not only how many marketing objects (e.g., coupons) were distributed, but also, how many were actually used and by whom.

In one implementation, upon receiving data in response to a request for merchants of a particular type, the consumer's computing device 120, 125, 135-150 may receive from the server 155 and display data pertaining to merchants of the type requested in the vicinity of the consumer. Such data may include graphical, textual, audio and video information, one or more of the foregoing, individually and in combinations. The data may include a merchant's name and address, contact information for the merchant, location information for the merchant, popularity as determined from cumulative total selections by consumers, consumer rating information such as a numerical rating or icon rating using notations such as a number of stars, spoons, chef's hats or the like, or some other indicator of a degree of consumer satisfaction. Thus, for example, a consumer computing device 120, 125, 135-150 may display a hyperlinked list of local merchants of the requested type in a particular order. The default order of display may be user selectable or fixed. The order of displayed local merchants may be sorted by proximity, consumer ratings, popularity, or some other distinguishing category.

Using one or more applications executed on the computing device 120, 125, 135-150, a consumer may navigate through the list, select a merchant to view additional information about the merchant, initiate an order process and input information and make selections to complete an order. Thus, for example, in the case of a list of local restaurants, a consumer may select a particular restaurant to view a menu for the restaurant. Additional information for a merchant may be provided from the service provider's system via the Internet 100 as a merchant is selected. Using the computing device 120, 125, 135-150, a consumer may navigate from the menu, back to the list, where the user can select another restaurant and continues reviewing menus. A menu may include product or service descriptions, product or service images, audio, video, pricing information, hyperlinked consumer reviews, and other information. Menu details may be displayed as selectable pictograms. Thus, menu items may be user selectable using the computing device 120, 125, 135-150 to add to a consumer's online shopping cart for the system. A user selectable button (i.e., user interface element that provides a user a way to trigger an event) for adding an item to a cart may be provided. When a menu item is selected or when a corresponding add to cart or purchase icon is selected, using the computing device 120, 125, 135-150, then the consumer is prompted to enter any necessary additional information, such as quantity or special requests (e.g., hold the pickles). An add-to-cart button may be associated with a quantity drop down list or combo box for specifying a quantity for an item added to a shopping cart. The menu item, quantity, and additional information may be stored in a shopping cart associated with a consumer's account. One example of such additional information, as indicated above, is special requests such as food preparation requests. Other types of special requests may include deferred delivery or recurrence. For example, a consumer may place an order for processing and pickup at a future date. As another example, a consumer may place a recurring order, e.g., a recurring weekday coffee order.

As another example, a subject matter of interest in a consumer directive may be a particular entertainer such as a specific musician, band or comedian. A marketing directive may identify as the subject matter of the marketing directive such entertainer in a particular location. The marketing object may comprise an announcement of a performance scheduled at that location and information pertaining to ticket sales. The system may send the marketing object to all users in the vicinity of the location who have identified the specific entertainer or genre of entertainment in a consumer directive. Thus, consumers may be notified of live performances, special appearance, book signings, talk show appearances by a particular celebrity, and the like.

As another example, which is a variation of the preceding example, subject matter of interest in a consumer directive may be a particular genre of live entertainment such as live rock, live country, stand-up comedy, a television show, an actor, a book or an author. A marketing directive may identify as the subject matter of the marketing directive a particular entertainer in a particular genre of entertainment performing live in a particular location. The marketing object may comprise an announcement of a performance scheduled at that location and information pertaining to ticket sales. The system may send the marketing object to all users in the vicinity of the location who have identified either the particular entertainer or genre in a consumer directive.

As another example, a consumer directive may identify a particular restaurant or a particular type of restaurant, or all restaurants. A marketing directive may be submitted for a restaurant in the vicinity of the consumer's then-current location, or in the vicinity of an address associated with the consumer. In each case, the marketing object associated with each such marketing directive will be made available to the consumer by the system.

As yet another example, a specific directive may seek all coupons for a particular retailer. Each active marketing directive from the retailer for a coupon may be retrieved in a query run in response to the specific directive. The associated coupons, as marketing objects, may then be made accessible to the consumer.

As still another example, a specific directive may seek all coupons for a particular manufacturer. Each active marketing directive from the manufacturer for a coupon may be retrieved in a query run in response to the specific directive. The associated coupons, as marketing objects, may then be made accessible to the consumer. Alternatively, a directive may seek marketing objects representing savings (e.g., coupons, sales or discounts) of a certain level for a particular product or range of products.

As another example, a specific directive may seek a coupon for a particular product. Each active marketing directive for a coupon for the product may be retrieved in a query run in response to the specific directive. The associated coupons, as marketing objects, may then be made accessible to the consumer. The product may be identified by a UPC code, brand and model, or by a barcode (e.g., a barcode imaged by a user using a mobile device).

A unique identifier is associated with each user. The identifier may be assigned at the time the user registers. Similar to a consumer loyalty card account number, the identifier may be utilized at compatibly equipped points of sale, whether brick and mortar or online, to apply coupons. To be compatibly equipped, the point of sale must be configured to transmit data to and receive data from a system according to principles of the invention. A user may be required to enter a PIN or password at checkout to authorize the transaction. The identifier may be stored on a magnetic stripe, as a scannable/readable barcode, electronically in a smart card, or on the display screen of a mobile computing device, or in a wirelessly communicated signal, or in a data packet communicated via network communication. The identifier not only identifies the user, but also identifies the system. Therefore, the point of sale system may poll the system of the invention for applicable coupons for the user.

In one embodiment, a Web crawler systematically browses the World Wide Web for the purpose of populating the databases 160, 165 with system-generated marketing directives. Starting with a list of seed URLs, the Web crawler visits the URLs, identifies all the hyperlinks in the page and adds them to the list of URLs to visit. Such URLs are recursively visited according to a set of policies. The crawler copies and saves website information as it goes. Copied information may include photos, product descriptions, pricing information, and URLs for each product on-sale on a website visited by the crawler. This information may be used to create a system-generated marketing directive and can be completely synchronized to match the consumer directives. (e.g., reduced pricing to specific marketing objects) The system may employ a metric of importance for prioritizing Web pages, by evaluating intrinsic quality and popularity in terms of links or visits. The importance of a page for the crawler can also be expressed as a function of the similarity of a page to a given query.

The system-generated marketing directive is associated with the product description and photo as a marketing object. The marketing object will be forwarded to each user with a consumer directive that matches a marketing directive. The marketing object may be stored in the database 170.

As repositories for product information, the databases 160, 165 may supply data to one or more online storefronts. The system may provide one or more store fronts for online shopping. The storefront is a Web store that is accessed by users to shop. Products offered for sale may be presented from the databases. Users may shop for goods and services via the storefront. Merchants may include their products in the store using a storefront administration system or by listing the products through marketing directives. A purchase icon may be displayed with items identified in marketing directives and on product pages of the storefront. Category, product, and other pages (e.g., search, bestsellers, etc.) may be dynamically generated by the storefront based on the information saved in the store database. By selecting a purchase icon, a shopping cart system is triggered. The shopping cart system is e-commerce software on a web server that allows users to select and accumulate a list of items for purchase. Upon checkout, the system calculates a total for the order, including shipping and handling (i.e., postage and packing) charges and taxes, as applicable. The shopping cart system provides a means of capturing a client's payment information. In the case of payment by credit card, the system relies on a secure gateway provider, in conjunction with the secure payment gateway, in order to conduct secure credit card transactions online. A store administration system may be accessed by the merchant to manage the online shop. Using the administration system, a store manager may add and edit products, categories, discounts, shipping and payment settings, etc.

Mobile device 120, 125 is a computing device as described above in reference to FIG. 1. The device 120 may include one or more processing units (CPU's) 200, memory such as RAM 205 and ROM 210, and a power supply 215. Additionally, the device 120 may include a display controller 220, a display 225 and a touch digitizer 230. These may comprise merely a few of the components of the mobile device 120. Various components may be implemented in hardware, software, or a combination of both hardware and software, including one or more signal processing and/or application specific integrated circuits.

The touch digitizer 230 comprises a touchscreen, an electronic visual display that the user can control through simple or multi-touch gestures by touching the screen with a special stylus/pen and/or one or more fingers. The touchscreen enables the user to interact directly with what is displayed, rather than using a mouse, touchpad, or any other intermediate device (other than a stylus, which is optional for most modern touchscreens). The touch digitizer 230 further comprises a transparent overlay covering the visual display. The overlay senses the touch of one or more fingers or a stylus. In response to a touch, the overlay produces a change in electrical properties (e.g., a change in current, voltage, capacitance or resistance). The touch digitizer interprets the commands that the changed electrical properties represent and communicates the commands to the appropriate applications. The touch digitizer 230 further comprises a display controller that receives and/or sends electrical signals from and to the visual display and overlay. Visual output may include graphics, text, icons, video, and any combination thereof (collectively termed “graphics”). In some embodiments, some or all of the visual output may correspond to user-interface objects. The display controller (along with any associated modules and/or sets of instructions in memory) detect contact (and any movement or breaking of the contact) on the overlay and converts the detected contact into interaction with user-interface objects (e.g., one or more soft keys, icons, web pages or images) that are displayed on touch-sensitive display. In an exemplary embodiment, a point of contact between touch digitizer 230 and the user corresponds to a finger of the user. The visual display may comprise LCD (liquid crystal display) technology, LPD (light emitting polymer display) technology, or LED (light emitting diode) technology, although other display technologies may be used in other embodiments. The overlay and display controller of the touch digitizer 230 may detect contact and any movement or breaking thereof, including speed (magnitude), velocity (magnitude and direction), and/or an acceleration (a change in magnitude and/or direction) of the point of contact, using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display. These operations may be applied to single contacts (e.g., one finger contacts) or to multiple simultaneous contacts (e.g., “multitouch”/multiple finger contacts).

Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

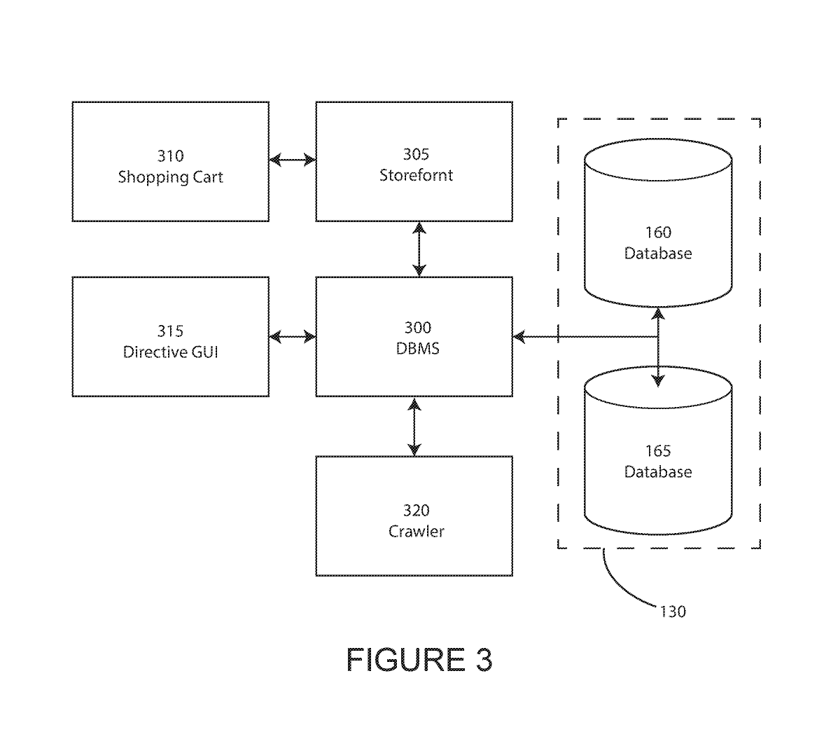

Referring now to FIG. 3, various modules of an exemplary system according to principles of the invention are conceptually illustrated. Modules may be implemented in hardware and/or in software (including firmware, resident software, micro-code, etc.). The database management system 300 (DBMS) stores, updates, sorts, queries and analyzes structured data in one or more databases 160, 165, and produces reports and output based on the data. Collectively, the databases are referred to as a database 170 or a repository or the like.

As repositories for product information, the database 170 may supply data to one or more online storefronts. The system may provide one or more storefronts 305 for online shopping. The storefront 305 is a Web store that is accessed by users to shop. Products offered for sale may be presented from the database 170. Users may shop for goods and services via the storefront 305. Merchants may include their products in the store using a storefront administration system or by listing the products through marketing directives. A purchase icon may be displayed with items identified in marketing directives and on product pages of the storefront. Category, product, and other pages (e.g., search, bestsellers, etc.) may be dynamically generated by the storefront based on the information saved in the database 170. By selecting a purchase icon, a shopping cart system 310 is triggered. The shopping cart system 310 is e-commerce software on a web server that allows users to select and accumulate a list of items for purchase. Upon checkout, the system 310 calculates a total for the order, including shipping and handling (i.e., postage and packing) charges and taxes, as applicable. The shopping cart system 310 provides a means of capturing a client's payment information. In the case of payment by credit card, the system 310 relies on a secure gateway provider, in conjunction with the secure payment gateway, in order to conduct secure credit card transactions online. A store administration system may be accessed by the merchant to manage the online shop. Using the administration system, a store manager may add and edit products, categories, discounts, shipping and payment settings, etc.

Using the computing device 120, 125, 135-150 and client software such as a browser or app, a user may create a directive. A Directive GUI 315 is the user interface for users to create and manage directives and implement slide-by displays. The interface includes controls and fields for directive creation and management and display of results. Management may entail activating, deactivating, reactivating, modifying and canceling a directive. As discussed above, each directive comprises an authoritative instruction pertaining to delivery of an electronically deliverable marketing object. The directive may be a consumer directive or a marketing directive. A consumer directive may be one of many different types, including, but not limited to, a location directive, a personal information directive, a general directive and a specific directive. The system stores data for each directive as one or more records in the database 170. Using the Directive GUI, a user may access, change and delete directives using the system. The GUI 315 allows a user to identify and select existing directives of that user and create new directives. A selected existing directive may be managed using the GUI 315. All existing directives may be displayed in a table, showing their title, creation date, effective dates, and other information related to the directives, to facilitate tracking and management.

A web crawler 320 systematically browses the World Wide Web for the purpose of populating the database 170 with system-generated marketing directives. Starting with a list of seed URLs, the Web crawler visits the URLs, identifies all the hyperlinks in the page and adds them to the list of URLs to visit. Such URLs are recursively visited according to a set of policies. The crawler copies and saves website information as it goes. Copied information may include photos, product descriptions, pricing information, and URLs for each product on-sale on a website visited by the crawler. This information may be used to create a system-generated marketing directive. The system may employ a metric of importance for prioritizing Web pages, by evaluating intrinsic quality and popularity in terms of links or visits. The importance of a page for the crawler can also be expressed as a function of the similarity of a page to a given query. System, Crawler, directives, or search processes, may also be created from semantic intelligence which translates and converts human language to machine language to perform actions.

Data may be supplied to the database 170 through other sources. As an example, a data feed may be provided for the database 170 to receive updated data from supplier (e.g., vendor and/or designer) data sources (e.g., databases). By way of example and not limitation, a CSV data feed may be used to load a CSV file to load product information from a supplier's database. The file may contain all data for all products from the supplier's database. Alternatively, the file may contain data for products that have changed since the last CSV file provided.

Data may also be supplied to the database 170 through the synchronization. One-way file synchronization, i.e., mirroring, may also be employed to update data copied into the database 170 from a supplier's data sources. Consistency among data from a supplier's source to the target data storage 170 may be established by timestamp synchronization. In this implementation, all changes to the source data are marked with timestamps. The time of all synchronizations are stored, at the source, at the target or at both locations. Synchronization proceeds by transferring all data with a timestamp later than the previous synchronization.

A supplier may also provide a portal (e.g., an enterprise information portal) (EIP), as a framework for making product information available. An administrator of a system according to principles of the invention may access the supplier's data through the supplier's EIP. Additionally, a system according to principles of the invention may automatically access the supplier's data through the supplier's EIP, such as by using a crawler to systematically browse the portal to update indexes and data in the database 170.

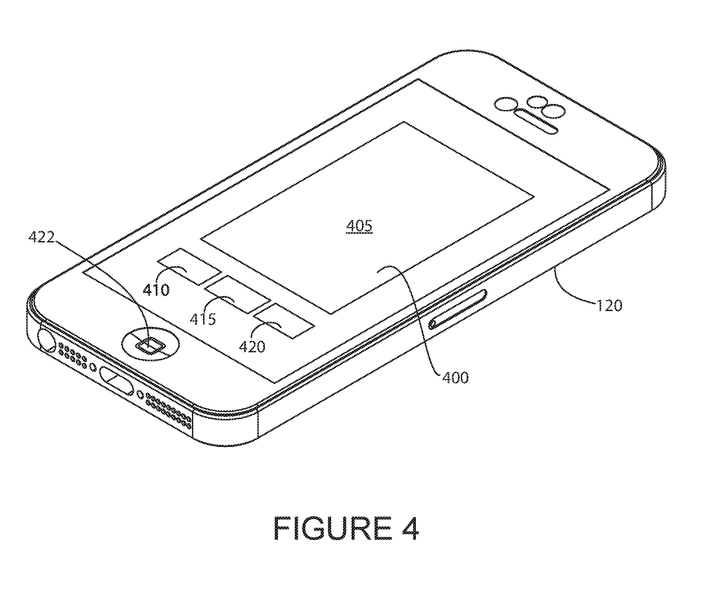

Referring now to FIG. 4, an exemplary mobile device 120 with a touch sensitive screen for use with an exemplary system according to principles of the invention is shown. The exemplary screen 400 displays a marketing object 405 and controls 410-420. The marketing object may be a coupon, discount code, product listing, product pictogram, or some other visual object. While three controls are shown, additional controls may be provided and located and arranged differently than as shown. The controls 410-420 trigger actions relative to the marketing directives and marketing object 405. The marketing object 405 may be removed from the screen 400 by swiping motion. In such case, the next or previous marketing object 405 in a series of marketing objects may be displayed on the screen 400. If there are no other marketing objects to display, a default display may be presented.

The displayed controls 410-420 may be dynamic, changing their content and functionality to work with the displayed marketing object 405. In one embodiment, the controls 410-420 may include a purchase button which allows a user to purchase a displayed product. In another embodiment, the controls 410-420 may include an apply-now button, allowing a user to use a coupon to make a purchase. In one embodiment, the controls 410-420 may include consumer directives which allow a user to activate specific directives and marketing objects of the user's choice to be displayed as products or services. (e.g. reduced price point, color, size, shorts) In yet another embodiment, the controls 410-420 may include a bookmark button, allowing a user to archive the marketing object 405 in a list of favorites. Other possible controls 410-420 include a share button, allowing a user to send the marketing object or a link thereto to a friend; a block button, allowing a user to block such marketing object in the future; and a button to bring up more available actions. These non-limiting examples illustrate the range of possible controls.

The app may be voice controlled. In one embodiment, control selections and other actions or directives may be performed using voice commands, using semantic intelligence which translates human language into machine language, using a microphone 422 and audio processing hardware and software of the mobile device 120.

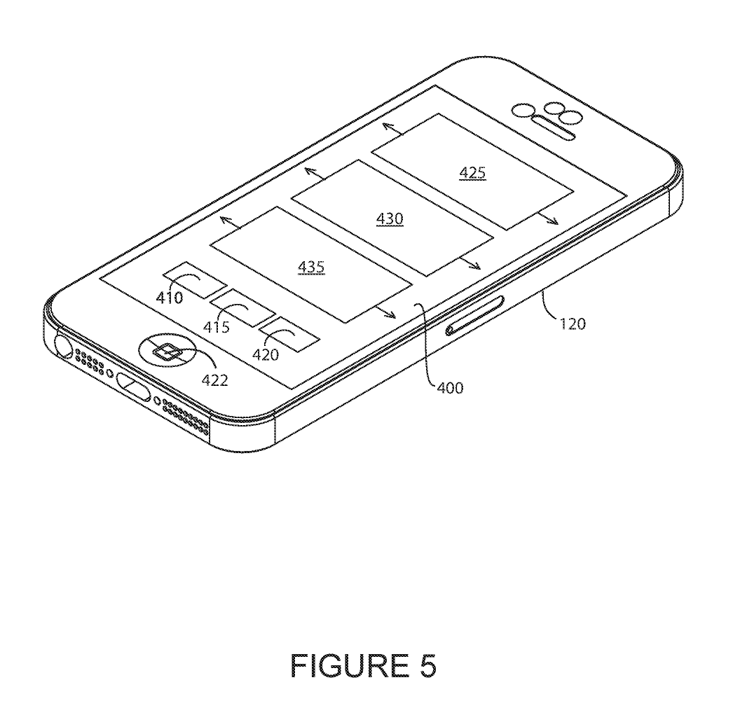

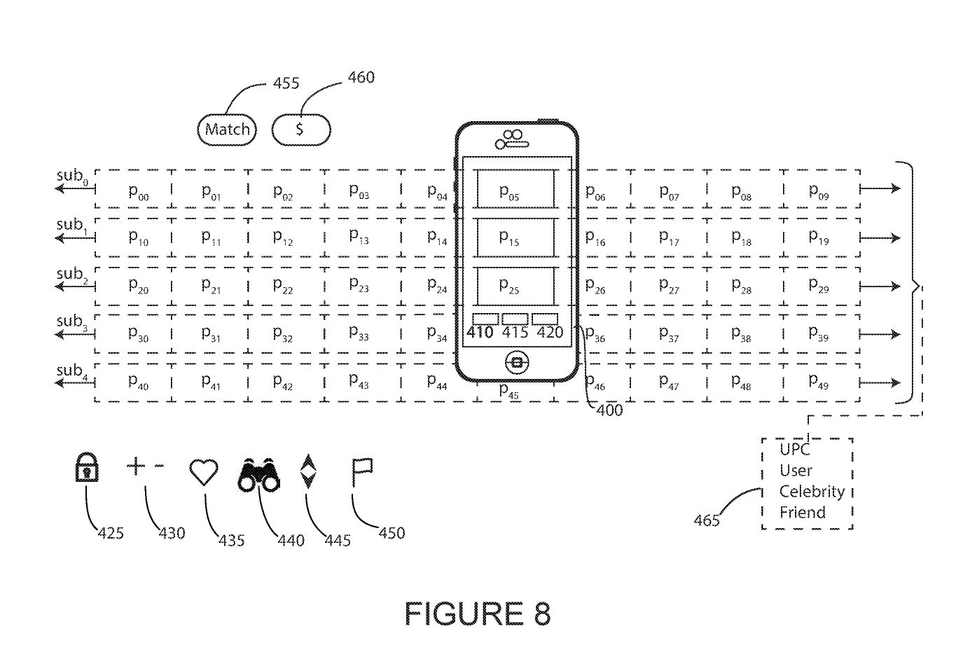

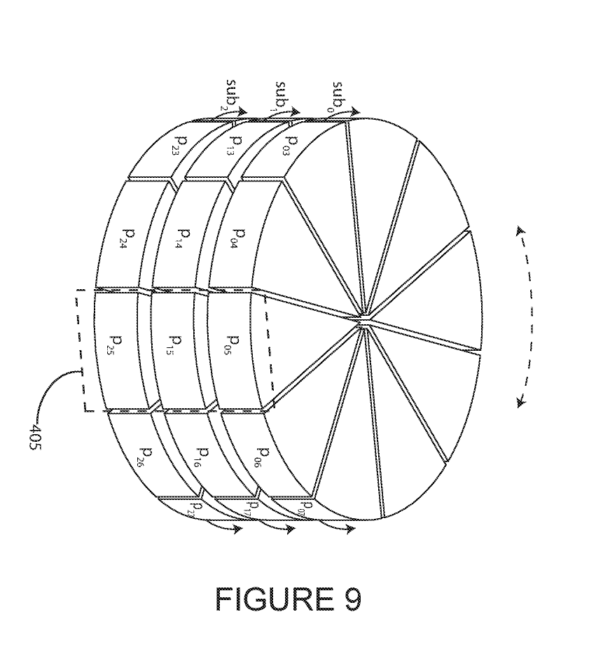

FIG. 5 is another perspective view of the exemplary mobile device 120 with a touch sensitive screen for use with an exemplary system according to principles of the invention. In this embodiment, the display is divided into a plurality (e.g., three) separate marketing object sections 425, 430, 435, each resembling a strip or reel. Each display section, referred to herein as a “strip” visually displays images of a plurality of products, in series, one next to another, as more clearly illustrated in FIGS. 8 and 9. The strips 425, 430, 435 are adjacent or abutting one another. Each strip 425, 430, 435 displays images of products (e.g., pictograms) that are related to the images of products displayed in each other strip of the display. Each strip 425, 430, 435 may be populated with a plurality of images, videos, pictograms, graphics, text or other displayable indicia, each an object image. The object images of a strip may be arranged in an order. Each strip 425, 430, 435 may slide in one dimension. A user may slide a strip 425, 430, 435 in one direction (e.g., right or up) or the opposite direction (e.g., left or down). As a strip slides, the object image that is displayed progresses (i.e., transitions) to the next or previous product image, in succession, in the strip, according to the order. Each strip 425, 430, 435 may slide independent of each other strip 425, 430, 435. Such a display, comprised of a plurality of adjacent or abutting strips, is referred to herein as a “slide-by” display, which is discussed in greater detail below.

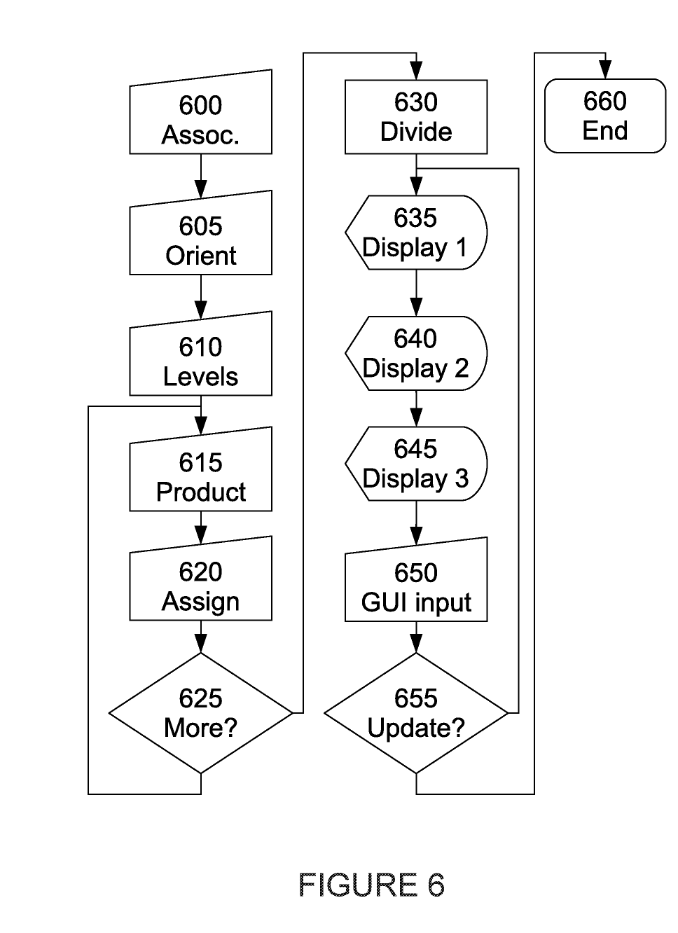

FIG. 6 is a high level flowchart of an exemplary method of simultaneously displaying and arranging a plurality of strips of photos or pictograms to facilitate browsing and purchasing decisions using an exemplary system according to principles of the invention. In step 600, strips are associated with the session, such as by selecting a control. The orientation and number of strips are specified in steps 605, 610. For example, FIG. 8 shows 5 strips stacked vertically. Next, products or, more broadly, objects, are associated with (i.e., assigned to) strips, as in steps 620, 625. After setting strips for a session, a strip may be designated for each browsed object. A user may select slide-by view to view the objects in levels. In step 630, the display is divided into the separate regions, including one for each strip. All strip assignments are stored, at least temporarily. The order in which objects are assigned is maintained, unless a user specifies a different order, such as by manipulating a list. Each strip is displayed with an assigned object, in steps 635 through 645. Each strip responds to GUI input, such as a finger swipe, as in step 650. Displayed objects are updated in response to GUI inputs, as in step 655. When completed with the session, a user may close the window, ending the multi-level display until selected again, as in step 660.

A slide-by display may include purchasing controls. A pictogram for a product may be linked to an online shopping cart. Alternatively, a purchase control may be associated with the slide-by display, allowing a user to purchase selected products using an online shopping cart, even products from various vendors.

A method of simultaneously displaying and arranging a plurality of photos or pictograms to facilitate browsing and purchasing decisions using an exemplary system according to principles of the invention may be implemented as an add-on, such as a plug-in or extension, to either a browser enabling smart phone application or a web browser. Implemented as an extension add-on to a browser, the methodology expands the core features of a web browser by adding one or more functional modules. These functional modules enable the collection of information and selections by a user and the display of photos or pictograms in accordance with the methodology.

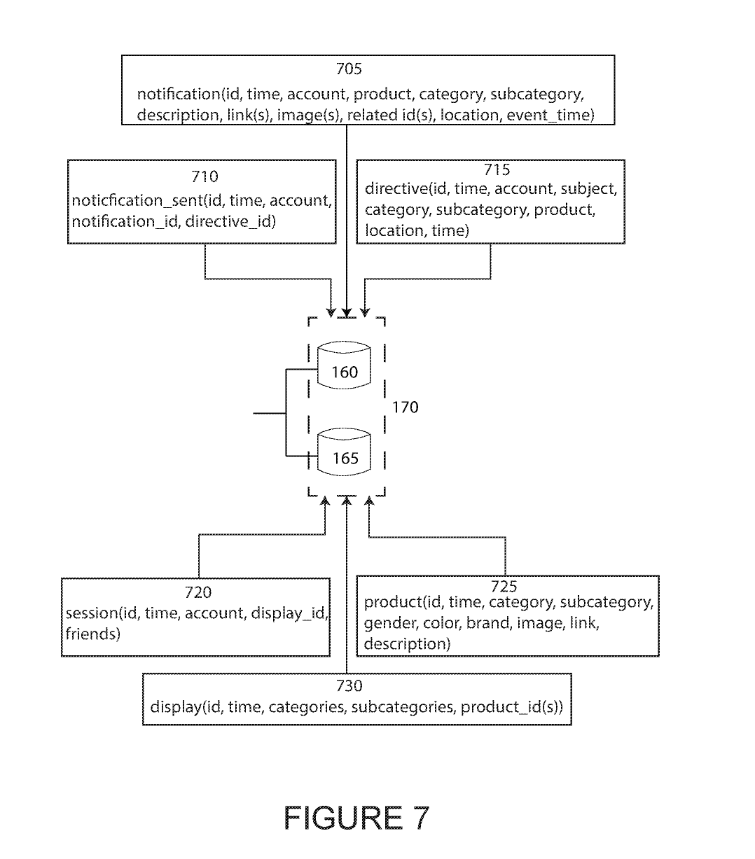

With reference to FIG. 7, an exemplary system according to principles of the invention stores and utilizes data pertaining to directives, notifications, user sessions, products and displays (e.g., slide-by-displays) on one or more data storage devices 160-170. Data storage may be transient or enduring. Stored data may include a notification 705. A notification 705 may be generated in response to a directive 715. Notifications may be pushed from a server 155 to a user (client) 120, 125, 135-150 based upon information preferences expressed in advance by the user. Various fields of data may be associated with each notification 705, including a unique identifier (id), a time of generation, an account (e.g., user account) associated with the notification, a product or service pertaining to the notification, categories and subcategories for the product or service, a description of the subject matter of the notification, links to relevant web pages, images or pictograms for the notification, identifications for other related products and services, location information, and event time for performances, broadcast, special events, appearances and the like. Notification sending data (notification sent) 710 may be stored to ensure delivery to all intended recipients and avoid duplicates. Various fields of data may be associated with each notification sent 710 record, including a unique identifier (id) for the record, a time of generation, an account (e.g., user account) associated with the notification, a notification identification, and a directive identification. Users can get notified on information that do not exist yet or information that is not known to the user to currently exist.

The notification is generated when a specified condition is satisfied. Conditions and notifications vary according to the subject matter. By way of example, a user may be notified when a product becomes available, is on sale (i.e., at a discount), or is offered by a vendor at or below a certain price, or is available as a refurbished or open-box item. A user may be notified when a vendor introduces a new product or a newer version or the next generation of a product. A user may be notified when tickets to an event are offered for sale. A user may be notified when a celebrity makes an appearance locally or on television, or is interviewed, or appears in a newly released movie, or makes a public announcement. A user may be notified of each show or movie at a particular venue. These are nonlimiting examples of conditions and notifications.

A user may specify a condition for notification using a user interface with form fields. The fields vary according to the subject matter to which the notification pertains. In the case of a product, fields may include a selling price below which a user is willing to purchase the product, availability at a specified venue, coupons, public announcements, and other variables pertaining to the marketing and sale of a product. In the case of a celebrity, the conditions for which notifications may be provided may include television appearances, in-person appearances, shows, announcements and the like.

A user's calendar may be updated with a notification. This is especially useful for time constrained notifications, such as notifications of conditions that will exist for a limited time (e.g., sales, live performances, coupons with expiration dates). Illustratively, an ics iCalendar file or other compatible calendar file or data stream may be sent (e.g. pushed) to a user's calendar app on the user's client computing device 120, 125, 135-150 to populate the local calendar with the date-related and/or time-related notification information. The process may be automated, requiring no user intervention. The process may be chronologically synchronized using auto-datafeeds.

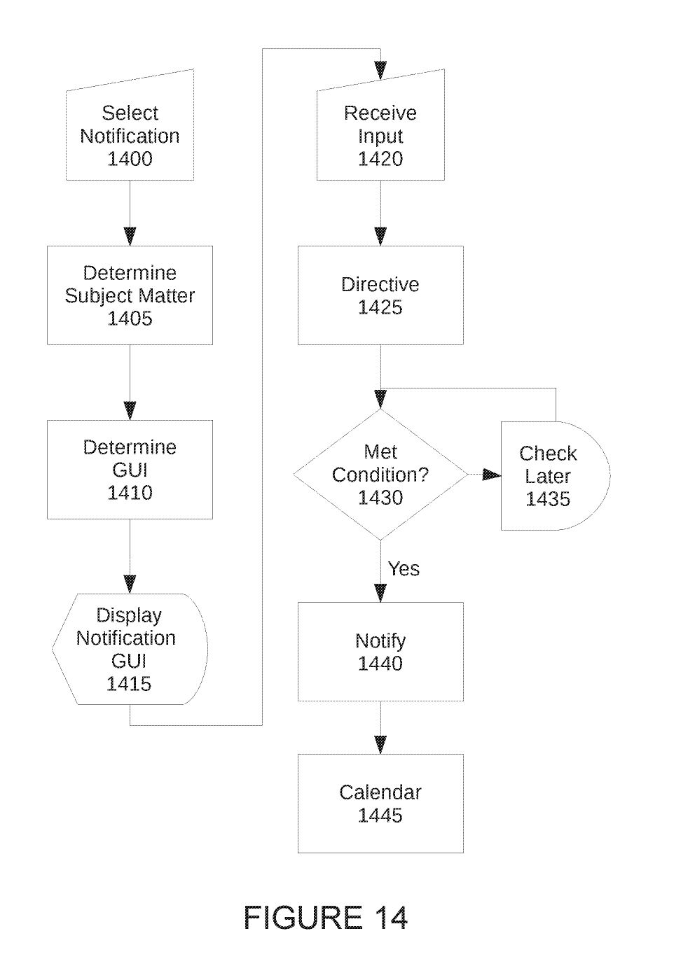

The flowchart of FIG. 14 conceptually illustrates steps of the notification process. A user may initiate a request for notification by selecting a notification icon, as in step 1400. The icon may be displayed adjacent to a display of the subject matter to which the notification pertains. Upon receiving a notification request, the system determines the type of subject matter to which the request pertains, as in step 1405. Upon determining the type of subject matter, the system determines the notification user interface to display for the determined subject matter, as in step 1410. The system correlates subject matter to available notification user interfaces. Each type of subject matter is associated with a notification user interface. The associations may be stored in tables or lists in the database 170. Upon determining the notification user interface to display, the system displays that user interface, as in step 1415. The user then supplies input through the user interface, as in step 1420. The user input specifies one or more conditions under which the user should be notified. The user may also specify one or more means for notification, such as a calendar posting, SMS, email, pop-up, or all or the foregoing then displays the determined user pertaining to subject matter displayed. A directive is generated using the user input and the subject matter, as in step 1425. Then, the system periodically repeatedly checks whether the condition(s) is(are) satisfied, as in steps 1430, 1435. When the condition(s) is(are) satisfied, a notification is sent, as in step 1440. The notification alerts the user of each condition that has been satisfied for the subject matter. The system, may also push a notification to a user's calendar, associated with a user's account, as in step 1445. The calendar may be configured to provide alerts to a user, via email, pop-up or alarm, for time-sensitive notifications (e.g., an event commencing on a certain date at a certain time).

Actions can also be selected to interact with television to receive information from a particular product or service to buy from a phone instantly. Celebrities, promoters, designers, television networks, television shows (e.g., QVC) radio networks may use such functionality to promote their shows and the products featured in their shows. A user may be notified of the date and time that a televised or radio broadcasted event, performance or appearance is occurring, or a product is being displayed on TV or discussed on radio. The notification may include a calendar entry. Concomitantly, the system may include a list, for each show or program, of products that appear in the show or program by time and date. The list may be linked to the notification and calendar entry provided to the user. A television show's calendar may synchronize with the user's calendar on their phone in real-time. When an action is selected the product shown in real-time will have a control for the user to select in real-time on their phone displaying the product on one or more strips in order to make a purchase.

Various fields of data may be associated with each directive 715, including a unique identifier (id) for the record, a time of generation, an account (e.g., user account) associated with the notification, a subject for the directive, a category for the directive, each subcategory for the directive, a product or service identification for the directive, location information for the directive, and timing information for the directive. Data for each session 720 may include a session identification, time information such as a start and end time, an account (e.g., user account) associated with the session, an identification for the subject matter displayed, and information regarding friends that supplied or received data during the session. Session information 720 may be shared among friends to allow friends to view the same display. During a session, a user may view one or more products, such as goods, services or events. A product record 725 may include various fields of associated data, including a unique product identification, a time added to the database, a category and one or more descriptive subcategories, such as, for example, gender, color and brand information, an image or pictogram, a link (e.g., hyperlink), and a description. For each display, such as a slide-by display, a unique identifier, time information, categories and subcategories, and product identifications may be stored. Thus, information for a user to replicate a particular display is stored and made available for communication to third parties. The information includes information regarding the session, the products displayed and the categories and subcategories covered.

With reference to FIG. 8, a slide-by display is conceptually illustrated. A plurality, in this case 5, strips are shown, stacked one upon another. The topmost strip is populated with information regarding a plurality of, in this case 10, products p00-p09 in a first subcategory of a category. The second strip, immediately below the topmost strip, is populated with information regarding a plurality of, in this case 10, products p10-p19 in a second subcategory of the category. The third strip, immediately below the second strip, is populated with information regarding a plurality of, in this case 10, products p20-p29 in a third subcategory of the category. The fourth strip, immediately below the third strip, is populated with information regarding a plurality of, in this case 10, products p30-p39 in a fourth subcategory of the category. The fifth strip, immediately below the fourth strip, is populated with information regarding a plurality of, in this case 10, products p40-p49 in a fifth subcategory of the category.

In a preferred implementation, products displayed in a strip have similar characteristics, as determined by descriptive information for each product, as stored in the database 170 or other data source. The descriptive information may comprise categories and subcategories. Categories are any of several fundamental and distinct classes to which objects belong. A few non-limiting examples of categories are clothing, food, cookware, and tools. Subcategories (e.g., sub₀, sub₁, sub₂, sub₃, sub₄, are any of several fundamental and distinct subclasses to which objects in a category belong. Illustratively, a few non-limiting examples of subcategories for clothing may be shoes, pants and shirts. Each of these subcategories may have subcategories. Examples of such subcategories are gender (e.g., male, female or unisex), brand, style (e.g., athletic, outdoor, work, evening, sleep), occasion (casual, formal), color, size, material, price, sale (e.g., yes/no, discount amount, discount percent), origin, popularity, review rating, etc. . . . . Subcategories may be related and may be hierarchical. For example, certain subcategories may apply only to certain higher level subcategories. Illustratively, a height subcategory may apply to a boot style subcategory in a category of footwear.

Categories, subcategories and relationships among categories and subcategories may be stored in one or more tables, databases or other data sources. A category and a plurality of subcategories may be associated with each product. Relationships among subcategories and combinations of subcategories may also be stored in one or more tables, databases or other data sources.

Category and subcategory information for a product may be supplied from a number of sources. Category and subcategory information for a product may be entered manually by a user or administrator. Category and subcategory information for a product may be obtained from an existing database, such as a manufacturer's database or an online retailer's database. Category and subcategory information may also be obtained from a style code (aka, style number).

Style codes have not been standardized by industry. Each style code may comprise a sequence of alphanumeric characters. Each character may correspond to a category or subcategory. Using the digits 0 through 9 and each letter of the alphabet (a-z) allows each character to specify one of 36 options. Thus, a ten character style code, allows up to 36′ (i.e., 3.656×10′⁵) possible combinations of categories and subcategories.

Style codes may be used to supply category and subcategory information for each product. A style code may also be used to characterize a product using categories and subcategories. Thus, category and subcategory information for a product may be stored in the form of a style code.

As style codes have not been standardized by industry, a symbology may be provided for each vendor's style code format. The symbology indicates the categories and subcategories covered by the style code and the meaning of each possible character. Using the correct symbology, each style code can be deciphered to determine the categories and subcategories for each product. Knowing the categories and subcategories for each product, a style code may be generated for each product in the database 170. Thus, categories and subcategories may be associated with each product in the database 170 using a style code. Such a style code may follow a predetermined consistent format and symbology for all products in the database.

In accordance with principles of the invention, a slide-by display may display strips for components of a woman's outfit. Illustratively, a strip for women's black evening shoes may be populated with pictograms for a plurality of such goods. Another strip for women's knee length skirts may be populated with pictograms for a plurality of such goods. A third strip for women's blouses may be populated with pictograms for a plurality of such goods. The three strips may comprise a slide-by display. A user may change the displayed shoes by sliding the shoe strip. Likewise, the displayed skirt and blouse may be changed by sliding the respective strips.

Style codes encoding categories and subcategories, or raw category and subcategory information, from the database 170, are utilized to populate each strip with objects (e.g., pictograms) for products of the same type. Thus, a strip for women's black evening shoes is populated with objects having style codes or category and subcategory values that indicate they are women's black evening shoes.

The strips may be arranged in various orders and manners. Strips may be arranged in a logical order. In the example provided above, a logical order may place the strip for the shoes on bottom, and the strip for the skirts between the strip for the shoes and the strip for the blouses.

To implement a logical ordering, an ordering rank may be associated with one or more subcategories or style codes. Ranking indicates the relevance of products displayed in one strip to products displayed in another strip. Illustratively, cross training shoes are more related to gym wear, than they are to formal wear. The ranking for cross training shoes may include an ordered list of subcategories to which the cross training shoes are related, with the strongest relationship first and the weakest relationship last. In this manner, the system may determine a logical arrangement of strips, and a logical selection of products to populate the strips.

The strips may be movable. The strips may be dragged by a user or moved by a user using up/down arrow button(s) 445 (FIG. 8) to a desired relative location. Thus, the strips may be arranged and rearranged according to a user's preferences.

A user may remove and add strips. A display may show 1, 2, 3 or more strips. Using a plus/minus (+−) control 430, one or more strips may be added or removed from a session. If a screen can display fewer than the total number of strips in an intelligible manner, the user may slide strips downwardly and upwardly to hide and reveal certain strips. Illustratively, the screen in FIG. 8 is configured to display 3 out of 5 strips. The two strips not visible on the screen may be displayed by sliding the strips upwardly.

A user may select a product to be displayed in a strip. A product is displayed in a strip when an object (e.g., image, pictogram, graphic or text) for the product is displayed in the strip. The object may be a pictogram that is hyperlinked to more detailed information and/or shopping cart functionality for the product.

User selection of a product to be displayed in a strip may be made using any of various input mechanisms and product data sources 465. A user may use a keyboard, pointer, touch screen, microphone or camera. By way of example and not limitation, the product may be selected by a user, determined from a manually entered UPC code, verbally dictated UPC code, or from a photographed barcode representing the UPC code, specified by a third party such as a friend or a followed celebrity. Illustratively, a user may request or accept a notification that provides information about a celebrity's attire at a particular event, or a user may select one or more products while browsing online, or a user may photograph a barcode, or a user may speak each digit of a UPC code into a microphone, or a friend may send product information to a user for use in a slide-by display, or a user may request a product by selecting product characteristics. These are non-limiting examples of processes for selecting a product to be displayed in a strip. Such a selected product may be considered an “anchor product.”

An anchor product is not displayed alone in a strip. Rather, it is displayed along with alternative products. An alternative product is a product having characteristics that are similar to the characteristics of the anchor product. Such characteristics are determined according to categories and subcategories associated with a product. A user may select alternative products to be displayed in a strip. Additionally, a system according to principles of the invention may populate a strip with alternative products to be displayed. The system determines similarity from the style code or categories and subcategories associated with the anchor product.

If a limited number of similar products are displayed in a strip, the limited number of products may be determined according to user selection or according to one or more algorithms, including algorithms basing selection on degree of similarity, popularity, ratings, price, or any other criteria that can be determined from the available data. Degree of similarity may be determined by the proximity of style codes, or the number of identical subcategory values for another product in the category.

A product may be marked as a favorite, and saved for future reference. Such marking may be accomplished using a favorite (e.g., heart) control 435. A binary favorite indicator is associated with each product in each strip. The indicator is set at “off” as a default. A user may change the favorite indicator from off to “on” by selecting a favorite icon 435. Each time the favorite icon 435 is selected, the indicator changes (e.g., from off to on, then from on to off, and so on). Product identification data for products marked as favorites may be entered in a table or list of favorites associated with the user's account. Such favorites may be retrieved and included in strips showing products of the kind.

Data for one or more strips and one or more products may be shared with another user. Sharing communicates data for the strips and/or products to the other user on a compatibly equipped computing device. Such data is associated with a session for the user's account, as discussed above with reference to FIG. 7. Thus, data to identify the session is communicated to the other user's computing device. From the session data, the other user's computing device may obtain from the database 170 the data necessary to replicate the display of products and strips. The other user is given the option of proceeding with the shared display. Unless the other user elects to proceed with the shared display by accepting it, the display is not generated on the other computer's computing device.

A product may be locked, such as by selecting a lock control 425. Locking is a form of user selection. A binary locking indicator is associated with each product in each strip. The indicator is set at unlocked as a default. A user may change the locking indicator by selecting a locking icon 425. Each time the locking icon 425 is selected, the locking indicator changes (e.g., from unlocked to locked, then from locked to unlocked, and so on). When a product is locked, it will remain in the strip. The system will not remove a locked product from a strip, without user instruction to do so.

Strips devoid of a selected product may be repopulated upon user instruction. The instruction is referred to herein as match or matching 455. A user initiates matching by selecting a match 455 icon. Matching repopulates each strip that does not contain a locked product with products that are particularly relevant to the locked products. Repopulation entails populating a strip using data collected for products that are particularly relevant to the locked products of other strips. Relevance may be determined by correlating the style codes or subcategories for a locked product with the style code or subcategories of candidates for repopulation, according to matching rules (i.e., rules of matching).

Matching rules may indicate style codes or subcategories for a product category that correlate with other style codes or subcategories of the same or another product category. The rules may organize the matching style codes or subcategories in order of matching relevance. Thus, matching data may be associated with each product. By way of example, a list of matching style codes, with wild cards, may be associated with each product. A wild cards is a symbol, such as *, $ or !, that represents the presence of any other unspecified character. The list may show the matching style codes in order of matching relevance, with the most relevant matching style codes being at the top of the list. The list may be constructed manually or automatically according to preset rules. For example, for athletic shoes matching products may include athletic apparel, with short sleeved shirts followed by long sleeved shirts followed by shorts, followed by pants and leggings.

Matching may be subjected to constraints, such as filters and limits. A filter may include or exclude one or more subcategory values from the matched data. For example, a filter may exclude certain brands or certain colors. A limit may exclude data for products having prices that exceed or fall below a user specified limit or outside of a user specified range. By way of example, a budget limit may filter out (i.e., exclude) product data for products priced at more than $100. Price constraints and other filters and limits may be set using the $ icon 460.

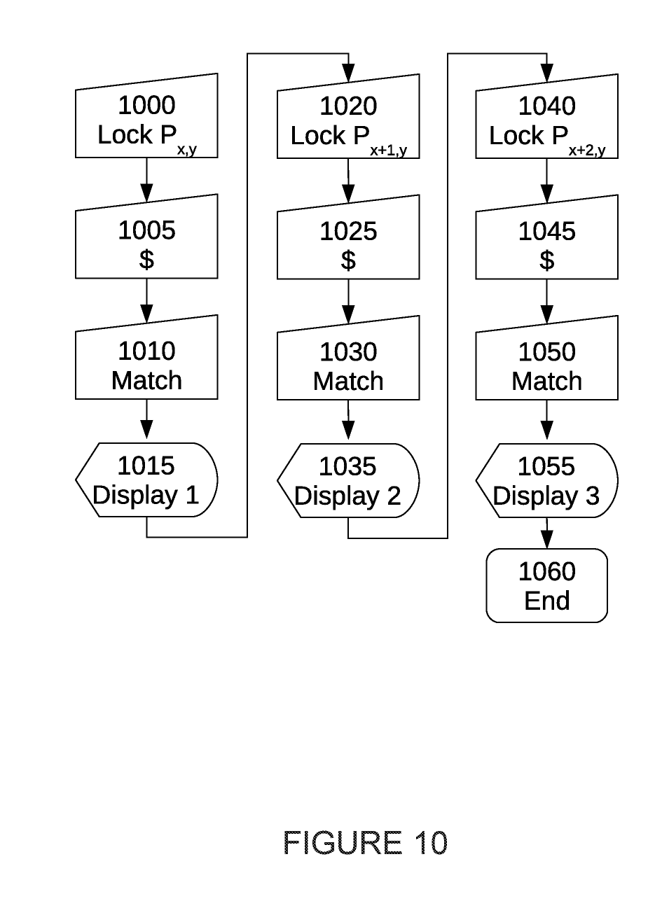

FIG. 10 provides a high level flowchart of steps of an exemplary matching process for a slide-by display with three strips according to principles of the invention. In step 1000 a product in a first strip, product p_{x,y}, is locked. A filter or limit, such as a price limit (e.g., $100), is set in step 1005. The match function is activated in step 1010. The system searches for products that: (a) match the locked product, product p_{x,y}, and (b) belong in each of the remaining strips, the second and third strips in this example, and (c) meet the set limit. The second and third strips are repopulated with objects for products that satisfy conditions (a) through (c) and the repopulated second and third strips are displayed along with the first strip, in step 1015. Next the user locks a product, product p_{x+1,y}, from the second strip, as in step 1020. A filter or limit, such as a price limit (e.g., $100), is set in step 1025. The filter or limit may be the same as or different from the filter or limit set in step 1005. The match function is activated in step 1030. The system searches for products that: (a) match the locked product, products p_{x,y} and p_{x+1,y}, and (b) belong in the remaining strip, the third strip in this example, and (c) meet the set limit. The third strip is repopulated with objects for products that satisfy conditions (a) through (c) and the repopulated third strip is displayed along with the first and second strip, in step 1035. Next the user locks a product, product p_{x+2,y}, from the third strip, as in step 1040. A filter or limit, such as a price limit (e.g., $100), is set in step 1045. The filter or limit may be the same as or different from the filter or limit set in step 1005. The match function is activated in step 1050. The system searches for products that: (a) match the locked product, products p_{x,y} and p_{x+1,y}, and (b) belong in the remaining strip, the third strip in this example, and (c) meet the set limit. The third strip is repopulated with objects for products that satisfy conditions (a) through (c) and the repopulated third strip is displayed along with the first and second strip, in step 1055. The matching process has then completed, as in step 1060. A product that meets the set limit has been locked in each of the three strips.

With continued reference to FIG. 8, a searching control 440 is provided for searching the database 170 for products, services, events and the like. Searching is performed using a search engine, i.e., an information retrieval software program, that discovers, crawls, transforms and stores information for retrieval and presentation in response to user queries. The search engine stores images, link data and metadata for the search results. Search results may be displayed in a separate window or tab. A strip may be populated with one or more of the search results as selected by a user. The search control may provide access to advanced searching options, including category and subcategory check boxes to limit the scope of the search to the selected categories and subcategories. Products viewed from a search may be added to a strip.

A notification icon 450 provides access to a notification function. The notification function associates a notification with a product, service or event and the user's account. The notification includes a notification condition. The notification condition may be a time, a target price, a sale, a discount a coupon, or some other condition related to the subject matter. Upon occurrence of the condition, the notification is made, i.e., the user is notified. Thus, for example, a user may use the notification icon 450 to set a notification condition for a product, such as “notify me when the product goes on sale.”

In yet another embodiment, the system includes a random display generator. Items in a strip are displayed in a dynamic sliding motion, stopping on a particular product, according to a computer generated random number. This mode of operation is referred to herein as slot machine mode. The user does not know or control where the sliding strip stops, when in slot machine mode. Slot machine mode may be activated when a long rapid swipe gesture is detected or when an icon is selected for such mode.

FIG. 9 is a schematic of display reels for a mobile device simultaneously displaying a plurality of objects to facilitate browsing and purchasing decisions using an exemplary system according to principles of the invention. In FIG. 9, the strips are illustrated as continuous reels, the idea being that the strip has no beginning and no end and the strips rotate rather than slide in either direction. The last and first products of each strip are adjacent to each other. Thus, if a user swipes a strip from the third product to the second product and to the first product and continues to swipe in the same direction, then the strip will move to the last product, and then to the second to last product and then to the third to last product in the strip. Likewise, if a user swipes a strip from the third to last product to the second to last product and to the first to last product and continues to swipe in the same direction, then the strip will move to the first product, and then to the second product and then to the third product in the strip. While 3 reels are shown for purposes of illustration, fewer or more reels (i.e., strips) may be used. Additionally, the reels do not have to be the same sizes, or do not have to have the same number of slices. Reels for less than or more than 9 products may be utilized.

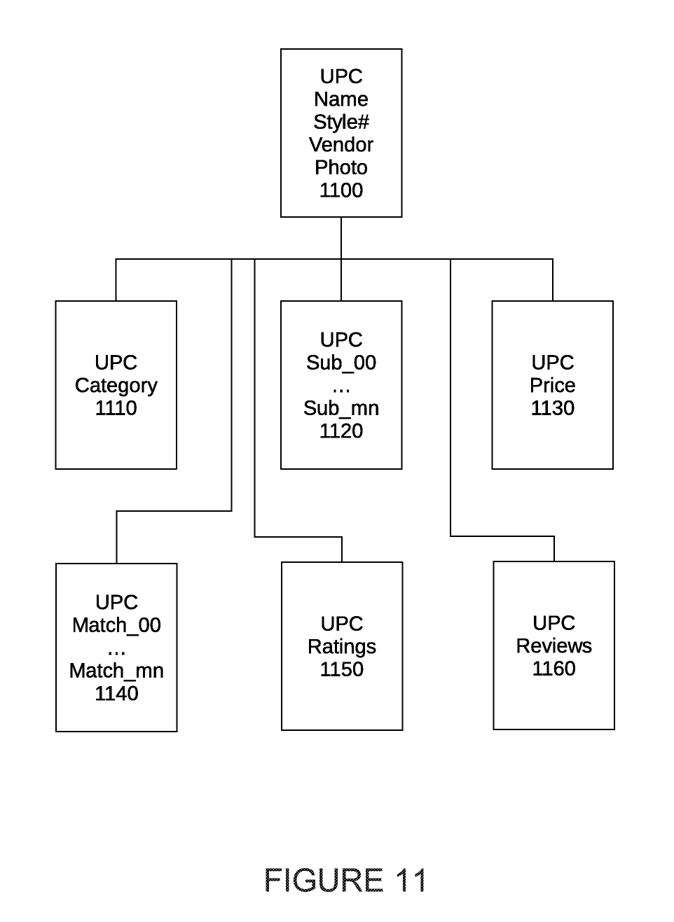

FIG. 11 provides a high level schematic of exemplary data relationships for a database for an exemplary system according to principles of the invention. A product 1100 may be identified with a Universal Product Code (UPC) or similar standardized code, a name, a style code as discussed above, a vendor identification, and a photo. A category 1110 is associated with each product. It is possible for more than one category to be associated with each product, particularly in the case of multi-purpose items. One or more subcategories 1120 are associated with each product. Price information 1130 is associated with each product. This information may also include information for applicable discounts, sales, promotions, coupons and the like. Each product may be associated with various matches 1140, i.e., related subcategories, for matching purposes, as described above. The matches may be identified using style codes or by identification of the correlated subcategories. Ratings 1150, such as consumer ratings, may be associated with each product. Reviews 1160, such as detailed consumer reviews, may be associated with each product. These items of data may be structured in lists and tables of the database 170.

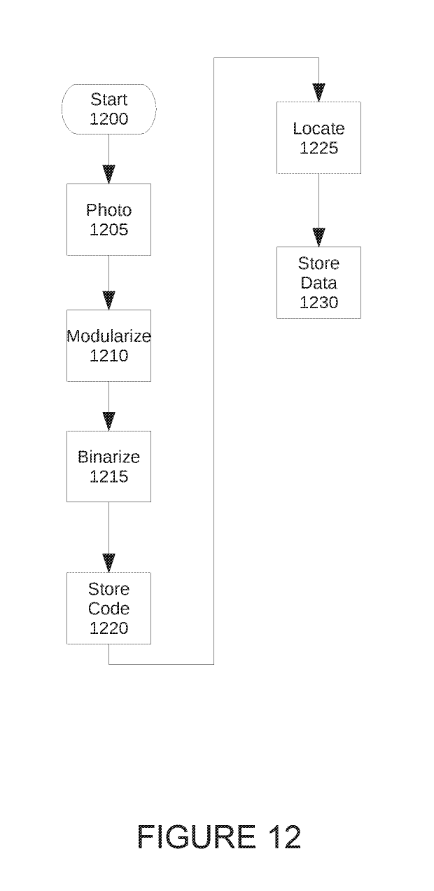

A product may be identified by photographing a barcode associated with the product, such as a barcode on a tag or packaging for the product at a retail establishment. FIG. 12 is a high level flow chart of a method of recognizing barcodes according to principles of the invention. A method and system according to principles of the invention may entail photographing and digitizing barcodes of items of interest to create a list. The process entails initializing an application, as in step 1200. The barcode of each product is photographed in gray scale, as in step 1205. The photograph is modularized based upon the barcode parameters, as in step 1210. Pixels darker than a threshold are considered black, while pixels below the threshold are considered white, according to the binarizing step 1215.

Standardized barcodes have certain specific proportions. In UPC-A, for example, the x-dimension is the width of single module element, which is nominally 0.33 mm (0.013 in.). In UPC-A the dark bars forming the Start, Middle, and End guard bars are extended downwards by 5 times x-dimension, with a resulting nominal symbol of height of 27.55 mm (1.08 in.). This also applies to the bars of the first and the last symbol characters of UPC-A symbol. UPC-A can be reduced or magnified anywhere from 80% to 200%. By determining areas comprising black bars and white spaces, a barcode is determined.

The barcode is stored in a table, list, array or other data structure, as in step 1220. The barcode may be converted to a digital code, e.g., a UPC, by applying the symbology to convert recognized module elements into characters (e.g., letters and/or digits). Stored barcode data (e.g., a stored UPC code determined by recognition of a photographed barcode) are used to access one or more databases 170 for product data, as in step 1225. The data, or pointers or links to the data, may then be stored for use in connection with a display during a user session, as in step 1230.

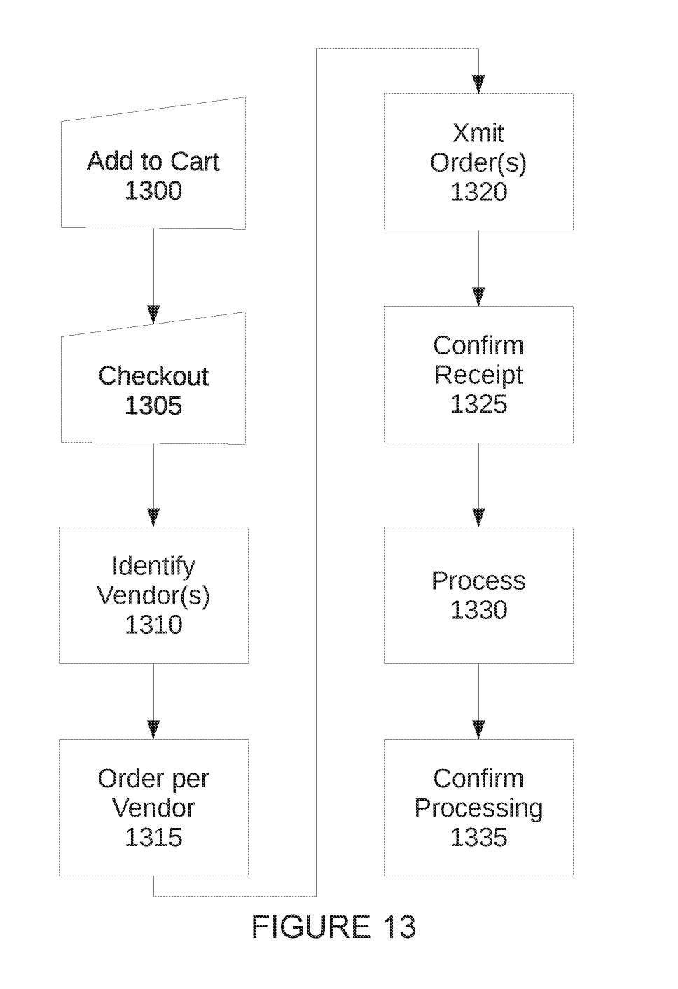

A system according to principles of the invention may include shopping cart functionality for a user to purchase selected items. The system provides an online marketplace with shopping cart functionality. Products displayed using the system, e.g., products in a slide-by display, may be selected for purchase by selecting an add to cart icon, as in step 1300 of the flowchart of FIG. 13. Each selected product is entered into a shopping cart, which may be reviewed and modified by the user prior to completing the purchase. A user may checkout, as in step 1305, by providing shipping and payment information.

In a particular preferred embodiment, the shopping cart functionality includes an order processor. The order processor is software that identifies vendors, as in step 1310, and generates one or more orders. A vendor for each product may be identified from the database 170. An order is generated for each vendor selling one or more products in the shopping cart, as per step 1315. Information comprising the order is obtained from user input into the user interface of a shopping cart. Each order includes a purchase order and payment information. Information for each order is obtained by parsing the information in the shopping cart, identifying each vendor of each product in the shopping cart and applying the customer, shipping and payment information. The processor encrypts each order and then sends the encrypted order to a vendor, as in step 1320. The purchase order and payment information may be combined (e.g., in one file or group of files) or may be kept separate. The purchase order includes information about the items purchased, quantities, shipping and customer. Each purchase order is vendor-specific, identifying only the products and quantities being purchased from that vendor, and not identifying the products or quantities being purchased from another vendor. The payment information includes all information necessary for the vendor to process the credit, debit or gift card payment and to associate the payment with the purchase order. Payment information may include information for payment using one or more accounts (e.g., cards or other means of payment). Illustratively, a consumer may request that a gift card be used and any balance be charged to a credit card. Alternatively, a user may request that a portion of the total purchase be charged to one card and another portion charged to one or more other cards.

The format, syntax and transmission of the order may conform to one or more industry standards or business specifications. Any information, syntax, format, protocols and standards required by the marketplace and vendors may be used. Payment information may be provided and transmitted according to industry standards, such as the Payment Card Industry Data Security Standard (PCI DSS). The purchase order may conform to electronic data interchange (EDI) standards for purchase orders. Orders may be communicated from the marketplace (e.g., a system according to principles of the invention) to vendors, using each vendor's gateway, port, feed and/or interface.

A vendor's system receives each order and associated payment information. Upon receipt, the vendor's system may send a confirmation of receipt, in the form of an electronic communication, as in step 1325. The vendor's system processes the order, as in step 1330, which entails decrypting the purchase order and payment information, parsing the purchase order, and fulfilling the purchase order and applying the payment information. Such fulfillment entails identifying the items for shipment, associating the shipping address with the shipment, and completing payment. The vendor's system may then send a confirmatory notice (i.e., another electronic communication) to the marketplace to confirm that the order has been processed, as in step 1335. If the order is defective of not processed for any reason, such as incorrect information in the order or improper syntax or format, the vendor's system may send a rejection notice to the marketplace.

In an alternative embodiment, the system includes an order processing web bot. The web bot automatically places orders on each vendor's online web store, using the information obtained from user input into the user interface of a shopping cart, comprising the order. The web bot selects the products on the vendor's online web store, specifies the quantities and proceeds with checkout using the vendor's shopping cart. The web bot inputs, into the vendor's shopping cart checkout forms, all required information, including the purchaser's billing and shipping address and payment information.

The aforementioned shopping cart functionality allows a user to use a single shopping cart to purchase items, through the marketplace of the system, from various vendors. The shopping cart functionality allows each vendor to electronically receive the order for that vendor's items to be sold. The shopping cart functionality allows each vendor to use its own preferred payment processing gateway to process payment information for fulfillment of the order. The shopping cart functionality allows the marketplace to stay out of the payment processing business. The shopping cart functionality allows a customer to checkout once for simultaneous purchases from various vendors.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method of displaying information for a plurality of products, including alternative products and related products, said method comprising steps of:
receiving data corresponding to an anchor product;
obtaining from a database, information regarding the anchor product, said information including an anchor product pictogram, a category association, and at least one subcategory association;
obtaining from the database, information regarding a first plurality of products, each product of the first plurality of products being an alternative to the anchor product and having a category association and a subcategory association that are the same as the category association and subcategory association for the anchor product, the information regarding the first plurality of products including, for each product of the first plurality of products, a product pictogram, the information regarding the first plurality of products comprising a first strip;
obtaining from the database, information regarding a second plurality of products, each product of the second plurality of products being related to the anchor product and having a category association that is the same as the category association for the anchor product, and having a subcategory association that is different from the subcategory association for the anchor product, the information regarding the second plurality of products including, for each product of the second plurality of products, a product pictogram, the information regarding the second plurality of products comprising a second strip;
simultaneously displaying a first displayable portion of the first strip and a second displayable portion of the second strip on a display screen of a computing device, the first strip including a first series of product pictograms, including the anchor product pictogram and each pictogram for each product of the first plurality of products, the first displayable portion comprising fewer than all of the pictograms in the first series of product pictograms, the second strip including a second series of product pictograms, including each pictogram for each product of the second plurality of products, the second displayable portion comprising fewer than all of the pictograms in the second series of product pictograms;
receiving a first user command to change the pictograms of the first series of product pictograms that are contained in the first displayable portion; and
in response to the received first user command, changing the pictograms of the first series of product pictograms that are contained in the first displayable portion; and
receiving a second user command to change the pictograms of the second series of product pictograms that are contained in the second displayable portion.
in response to the received second user command, changing the pictograms of the second series of product pictograms that are contained in the second displayable portion.

2. The method of displaying information for a plurality of products according to claim 1, further comprising:
obtaining from the database, information regarding a third plurality of products, each product of the third plurality of products being related to the anchor product and having a category association that is the same as the category association for the anchor product, and having a subcategory association that is different from the subcategory association for the anchor product and different from the subcategory association for the second plurality of products, the information regarding the third plurality of products including, for each product of the third plurality of products, a product pictogram, the information regarding the third plurality of products comprising a third strip;
simultaneously displaying a third displayable portion of the third strip with the simultaneously displayed first displayable portion of the first strip and the second displayable portion of a second strip on the display screen of the computing device, the third strip including a third series of product pictograms, including each pictogram for each product of the third plurality of products, the third displayable portion comprising fewer than all of the pictograms in the third series of product pictograms; and
receiving a third user command to change the pictograms of the third series of product pictograms that are contained in the third displayable portion; and
in response to the received third user command, changing the pictograms of the third series of product pictograms that are contained in the third displayable portion.

3. The method of displaying information for a plurality of products according to claim 2, further comprising:
obtaining from the database, information regarding a fourth plurality of products, each product of the fourth plurality of products being related to the anchor product and having a category association that is the same as the category association for the anchor product, and having a subcategory association that is different from the subcategory association for the anchor product and different from the subcategory association for the second plurality of products and different from the subcategory association for the third plurality of products, the information regarding the fourth plurality of products including, for each product of the fourth plurality of products, a product pictogram, and comprising a fourth strip.

4. The method of displaying information for a plurality of products according to claim 3, further comprising:
determining a fourth displayable portion of a fourth strip, the fourth strip comprising a fourth series of product pictograms, including each pictogram for each product of the fourth plurality of products, the fourth displayable portion comprising fewer than all of the pictograms in the fourth series of product pictograms; and
receiving a user scroll command;
in response to the user scroll command, simultaneously displaying on the display screen of the computing device three displayable portions of the first displayable portion, second displayable portion, third displayable portion and fourth displayable portion, the three displayable portions being determined by the user scroll command.

5. The method of displaying information for a plurality of products according to claim 4, further comprising:
receiving a fourth user command to change the pictograms of the fourth series of product pictograms that are contained in the fourth displayable portion; and
in response to the received fourth user command, changing the pictograms of the fourth series of product pictograms that are contained in the fourth displayable portion.

6. The method of displaying information for a plurality of products according to claim 1, wherein the step of receiving data corresponding to an anchor product comprises entering into the computing device a product code for the anchor product.

7. The method of displaying information for a plurality of products according to claim 1, wherein the step of receiving data corresponding to an anchor product comprises determining a product code for the anchor product from a photograph of a barcode representation of a product code for the anchor product.

8. The method of displaying information for a plurality of products according to claim 1, wherein the step of receiving data corresponding to an anchor product comprises receiving data corresponding to an anchor product from a remote computer via a communications network.

9. The method of displaying information for a plurality of products according to claim 1, wherein the step of receiving a first user command to change the pictograms of the first series of product pictograms that are contained in the first displayable portion comprises swiping a finger across the first displayable portion on a touch sensitive screen.

10. The method of displaying information for a plurality of products according to claim 1, wherein the step of receiving a first user command to change the pictograms of the first series of product pictograms that are contained in the first displayable portion comprises receiving swiping gesture input from a finger swiped across the first displayable portion on a touch sensitive screen.

11. The method of displaying information for a plurality of products according to claim 1, an anchor product style code for the anchor product encoding the category association for the anchor product and the at least one subcategory association for the anchor product;
a first plurality of style codes, including one style code for each of the first plurality of products, encoding the category association for each of the first plurality of products and the subcategory associations for each of the first plurality of products; and
a second plurality of style codes, including one style code for each of the second plurality of products, encoding the category association for each of the first plurality of products and the subcategory associations for each of the first plurality of products.

12. The method of displaying information for a plurality of products according to claim 2,
an anchor product style code for the anchor product encoding the category association for the anchor product and the at least one subcategory association for the anchor product;
a first plurality of style codes, including one style code for each of the first plurality of products, encoding the category association for each of the first plurality of products and the subcategory associations for each of the first plurality of products; and
a second plurality of style codes, including one style code for each of the second plurality of products, encoding the category association for each of the first plurality of products and the subcategory associations for each of the first plurality of products; and
a third plurality of style codes, including one style code for each of the third plurality of products, encoding the category association for each of the first plurality of products and the subcategory associations for each of the first plurality of products.

13. The method of displaying information for a plurality of products according to claim 2,
receiving a user command to repopulate the second plurality of products and the third plurality of products;
in response to the user command to repopulate the second plurality of products and the third plurality of products, obtaining from the database, information regarding a fifth plurality of products, each product of the fifth plurality of products being related to the anchor product and having a category association that is the same as the category association for the anchor product, and having a subcategory association that is different from the subcategory association for the anchor product, the information regarding the fifth plurality of products including, for each product of the fifth plurality of products, a product pictogram, the information regarding the fifth plurality of products comprising a fifth strip, the fifth strip replacing the second strip;
obtaining from the database, information regarding a sixth plurality of products, each product of the sixth plurality of products being related to the anchor product and having a category association that is the same as the category association for the anchor product, and having a subcategory association that is different from the subcategory association for the anchor product, the information regarding the sixth plurality of products including, for each product of the sixth plurality of products, a product pictogram, the information regarding the sixth plurality of products comprising a sixth strip, the sixth strip replacing the third strip;
simultaneously displaying the first displayable portion of the first strip, the fifth displayable portion of the fifth strip and the sixth displayable portion of the sixth strip on the display screen of the computing device, the fifth strip including a fifth series of product pictograms, including the anchor product pictogram and each pictogram for each product of the fifth plurality of products, the fifth displayable portion comprising fewer than all of the pictograms in the fifth series of product pictograms, the sixth strip including a sixth series of product pictograms, including each pictogram for each product of the sixth plurality of products, the sixth displayable portion comprising fewer than all of the pictograms in the sixth series of product pictograms.

14. The method of displaying information for a plurality of products according to claim 13, the information regarding the first plurality of products, including a lock status associated with each product of the first plurality of products, the lock status having a setting from the group consisting of locked and unlocked.

15. The method of displaying information for a plurality of products according to claim 14, the step of receiving a user command to repopulate the second plurality of products and the third plurality of products comprising a step of setting the lock status for at least one of the products of the first plurality of products to a locked status.

16. The method of displaying information for a plurality of products according to claim 13, the step of obtaining from the database, information regarding a fifth plurality of products, further comprising receiving a user-specified constraint for the fifth and sixth plurality of products, and obtaining from the database, information regarding a fifth plurality of products that meet the user-specified constraint for the fifth and sixth plurality of products; and
the step of obtaining from the database, information regarding a sixth plurality of products, further comprising obtaining from the database, information regarding a sixth plurality of products that meet the user-specified constraint for the fifth and sixth plurality of products.

17. The method of displaying information for a plurality of products according to claim 3,
receiving a user command to repopulate the second plurality of products, the third plurality of products and the fourth plurality of products;
in response to the user command to repopulate the second plurality of products, the third plurality of products and the fourth plurality of products, obtaining from the database, information regarding a fifth plurality of products, each product of the fifth plurality of products being an alternative to the anchor product and having a category association and a subcategory association that are the same as the category association and subcategory association for the anchor product, the information regarding the fifth plurality of products including, for each product of the fifth plurality of products, a product pictogram, the information regarding the fifth plurality of products comprising a fifth strip, the fifth strip replacing the second strip;
obtaining from the database, information regarding a sixth plurality of products, each product of the sixth plurality of products being related to the anchor product and having a category association that is the same as the category association for the anchor product, and having a subcategory association that is different from the subcategory association for the anchor product, the information regarding the sixth plurality of products including, for each product of the sixth plurality of products, a product pictogram, the information regarding the sixth plurality of products comprising a sixth strip, the sixth strip replacing the third strip;
obtaining from the database, information regarding a seventh plurality of products, each product of the seventh plurality of products being related to the anchor product and having a category association that is the same as the category association for the anchor product, and having a subcategory association that is different from the subcategory association for the anchor product, the information regarding the seventh plurality of products including, for each product of the seventh plurality of products, a product pictogram, the information regarding the seventh plurality of products comprising a seventh strip, the seventh strip replacing the fourth strip;
simultaneously displaying the first displayable portion of the first strip, a fifth displayable portion of the fifth strip and a sixth displayable portion of the sixth strip on a display screen of a computing device, the fifth strip including a fifth series of product pictograms, including the anchor product pictogram and each pictogram for each product of the fifth plurality of products, the fifth displayable portion comprising fewer than all of the pictograms in the fifth series of product pictograms, the sixth strip including a sixth series of product pictograms, including each pictogram for each product of the sixth plurality of products, the sixth displayable portion comprising fewer than all of the pictograms in the sixth series of product pictograms.

18. The method of displaying information for a plurality of products according to claim 17, the information regarding the first plurality of products, including a lock status associated with each product of the first plurality of products, the lock status having a setting from the group consisting of locked and unlocked.

19. The method of displaying information for a plurality of products according to claim 18, further comprising
receiving purchase information for at least two products of the plurality of products, the purchase information including a purchase selection associated with each of the two products, and further including payment information for the two products, and
generating a first order from the purchase information for one of the two products, and
generating a second order from the purchase information for another of the two products, and
encrypting the first order,
encrypting the second order,
electronically communicating the first order to a first vendor computer system for processing and fulfillment; and
electronically communicating the second order to a second vendor computer system for processing and fulfillment.

20. The method of displaying information for a plurality of products according to claim 18, further comprising requesting a notification for at least one product of the plurality of products, the notification relating to a condition associated with the at least one product of the plurality of products, and
periodically determining if the condition is satisfied, and
if the condition is satisfied, communicating the notification to a calendar.
